(19) United States
(12) Patent Application Publication
(10) Pub. No.: US 2012/0066088 A1
(43) Pub. Date: Mar. 15, 2012

(54) INTERACTIVE JOB CHART

(76) Inventor: Greggory Murset, Queen Creek, AZ (US)

(21) Appl. No.: 13/249,637

(22) Filed: Sep. 30, 2011

Related U.S. Application Data
(63) Continuation-in-part of application No. 12/729,122, filed on Mar. 22, 2010.
(60) Provisional application No. 61/388,329, filed on Sep. 30, 2010.
(60) Provisional application No. 61/162,581, filed on Mar. 23, 2009.

(51) Int. Cl. G06Q 30/06; G06F 17/30; G06F 7/50

(52) U.S. Cl. 705/26.8; 708/670; 707/792; 707/737; 705/26.1

(57) ABSTRACT

A machine for tracking job completion is disclosed. The machine for tracking job completion includes a software program that users can execute. Users are classified as either parents or children. Users classified as parents are allowed to use an assign jobs utility, an assign reward utility, a family member definition utility, and a parent send message utility. Parents use these utilities to define and assign jobs to a child and define and assign rewards the child can earn by completion of the jobs. Users classified as children are allowed to use a job credit utility, a reward purchase utility, an organize points utility, and a child send message utility. Children use these utilities to track job completion and purchase rewards earned by job completion. Child users can spend earned points on rewards that allow them to save money or rewards points, and/or contribute their earned money to charity.

### CROSS REFERENCE TO RELATED APPLICATIONS

This application is a continuation-in-part of the earlier U.S. Utility Patent Application to Greggory Murset entitled “Interactive Job Chart,” Ser. No. 12/729,122, filed Mar. 22, 2010, which claims priority to U.S. Provisional Patent Application to Greggory T. Murset entitled “Interactive Job Chart Systems,” Ser. No. 61/162,581, filed Mar. 23, 2009, the disclosures of which are hereby incorporated entirely herein by reference. This application also claims priority to U.S. Provisional Patent Application to Greggory T. Murset entitled “Interactive Job Chart,” Ser. No. 61/388,329, filed Sep. 30, 2010, the disclosure of which is hereby incorporated entirely herein by reference.

### BACKGROUND OF THE INVENTION

1. Technical Field

The present invention relates generally to the field of task logging and more specifically relates to a machine for tracking job completion.

2. State of the Art

Parents delegate many tasks to their children as a means for teaching and for instilling a sense of responsibility, work ethic and accountability in them as they grow towards maturity. Many of the tasks are single work events and others are designed to aid in the learning process on an on-going basis. Problems may exist in tracking these tasks and/or events over a period of time. Further, the tasks when accomplished may not be accurately recorded showing a direct relationship between the work accomplished and the reward earned.

Task management methods and systems are known for planning, scheduling and control within organizations, such as those described in U.S. Pat. Nos. 6,445,986, 6,101,481, 5,016,170, 5,893,074, 6,223,201, and 6,035278. Programs such as Microsoft Project are currently employed to assist project managers in developing plans, assigning resources to tasks, tracking progress, managing budgets and analyzing workloads. Programs such as these are efficient for use with projects and task management, however are complex and not user-friendly for laymen and especially children. These task management systems also fail to directly correlate task completion with reward. Another need that has not been addressed by the current programs is the ability to permit personable interaction and communication between parents and children on an informal basis.

Ideally, a job tracking system should be convenient and fun to use for parents and children. The system should be accessible, and provide a progress tracking means using a task/reward correlation that is customizable to the child. Thus, a need exists for a user-friendly job tracking machine to avoid the above-mentioned problems.

### DISCLOSURE OF THE INVENTION

The present invention relates to the field of task logging and more specifically relates to a machine for tracking job completion. The machine according to the invention includes a processor, a memory, and a software program stored on the memory and operated by the processor. The software tool includes a participant list containing participant names. Associated with each participant name is participant profile data. The participant profile data includes an earned point value and a job list. The job list contains a list of names assigned to the participant. Each job name has job data assigned to it, the job data comprising a job point value and a job completion indicator, wherein the job completion indicator indicates whether the job has been completed or not. The software program also includes a job completion credit utility and a user interface utility. The job completion credit utility adds the job point value to the earned point value in response to the job completion indicator indicating that the job is complete. The user interface utility is coupled to an input/output device, and allows users of the software program to interact with the software program. In some embodiments the participant data also includes a rewards purchased list, a reward shopping cart list, and reward data. The rewards purchase list is a list of reward names purchased by the participant. The reward shopping cart list contains a reward name. The reward data contains data assigned to the reward name. The reward data includes a reward point value and a reward purchase indicator. The reward purchase indicator indicates whether purchase of the reward name is to be executed or not. In some embodiments the software program includes a reward purchase utility. The reward purchase utility places the reward name on the reward purchased list, removes the reward name from the shopping cart list, and subtracts the reward point value from the earned point value in response to the reward purchase indicator indicating that purchase of the reward name is to be executed. In some embodiments the reward purchase utility is linked to store websites to allow purchase of store items. In some embodiments the software program includes a calendar utility which adds job names to the job list according to a predetermined calendar schedule. In some embodiments the job data includes a job due date that is the date that the job is to be completed by. In some embodiments bonus points are added to the earned point value in response to the job being completed a predetermined amount of time prior to the job due date.

In some embodiments the machine for tracking job completion divides up the users of the software program into families. The machine for tracking job completion includes a memory with an executable software program stored on the memory. The memory instructs a microprocessor to perform the steps of registering a plurality of users of the software program, and dividing up the plurality of users of the software program into a plurality of family sets. Each family contains a list of users that are family members. A family contains at least one parent user and at least one child user. Each family includes at least two users, since a user cannot be classified as both a parent user and a child user. At log-in the software program allows each user to select their name or photo from the list of family members that comprises their family. Users classified as parents are allowed to access and/or execute an assign jobs utility, an assign rewards utility, and a parent send message utility of the software program. The assign jobs utility allows a parent to define a job name, job data, and assign the job name to a child participant. The software program restricts each child user from accessing the assign jobs utility. The assign rewards utility stores a share reward list that includes a share reward name and a share reward point amount, where the share reward point amount is associated with the share reward name. In some embodiments the assign rewards utility stores a save reward list that includes a save reward name and a save reward point amount, where the save reward point amount is associated with the save reward name. In some embodiments the assign rewards utility stores a spend reward list that includes a spend reward name and a spend reward point amount, where the spend reward point amount is associated with the spend reward name. In some embodiments the assign rewards utility allows a parent to define a reward name, reward data, and assign the reward name to the reward list of a child participant. The parent send message utility allows a parent user to exchange secure messages with the other members of their family.

Users classified as children are allowed to access and/or execute the job credit utility, the reward purchase utility, an organize points utility, and a child send message utility. The organize points utility divides the earned point value up into a save points value, a share points value, and a spend points value. The save points value can be used by the child to purchase save rewards. The share points value can be used by the child to purchase share rewards. The spend points value can be used by the child to purchase spend rewards. The child send message utility allows the child user to exchange secure messages with the parent members of their family. In some embodiments the child send message utility allows the child user to exchange secure messages with all of the other members of their family.

The invention discloses a memory with an executable software program stored on the memory. The software program instructs a microprocessor to perform a number of steps including storing participant profile data assigned to a participant name, wherein the participant profile data includes an earned point value and a job list. The job list includes a job name. The software program instructs the microprocessor to store job data assigned to the job name. The job data includes a job point value and a job completion indicator. The job completion indicator indicates whether the job has been completed or not. The software program instructs the microprocessor to perform crediting of job completion by performing the job completion step of adding the job point value to the earned point value in response to the job name having a job completion indicator indicating the job name is complete. In some embodiments the job completion steps include sending an email to a predetermined email address to report job completion. In some embodiments the participant profile data also includes a rewards purchased list and a reward shopping cart list which includes a reward name. In some embodiments the microprocessor is instructed to perform the steps of storing reward data assigned to the reward name. The reward data include a reward point value and a reward purchase indicator. The reward purchase indicator indicates whether purchase is to be executed or not. In some embodiments the microprocessor is instructed to perform purchasing of a reward by performing reward purchase steps in response to the reward purchase indicator indicating that reward purchase is to be executed. The reward purchase steps include subtracting the reward point value from the earned point value, adding the reward name to the rewards purchased list, and removing the reward name from the reward shopping cart list. In some embodiments the reward purchase steps include sending an email to a predetermined email address to report reward purchase. In some embodiments the reward purchase steps include posting the reward name to a predetermined social networking site to report reward purchase. In some embodiments the software program instructs the microprocessor to perform providing a participant interface tool, wherein the participant interface tool allows a user of the software program that is associated with the participant name to interact with predetermined participant profile data. In some embodiments the software program instructs the microprocessor to perform providing an administrator interface tool, wherein the administrator interface tool allows an administrator of the software program to define the participant name and interact with all of the participant profile data.

A machine for tracking job completion is disclosed, where the machine includes a microprocessor coupled to a memory, and a software program installable on the memory and operated by using the microprocessor. The software program includes an accumulate points utility and an organize points utility. The accumulate points utility instructs the microprocessor to add an earned point value to a points to organize value. The organize points utility instructs the microprocessor to perform the steps of subtracting an organize save points value from the points to organize value, and adding the organize save points value to a save points value. In some embodiments the organize points utility further instructs the microprocessor to perform the steps of subtracting an organize share points value from the points to organize value, and adding the organize share points value to a share points value. In some embodiments the organize points utility further instructs the microprocessor to perform the steps of subtracting an organize spend points value from the points to organize value, and adding the organize spend points value to a spend points value. In some embodiments the software program further comprises an assign rewards utility, wherein the assign rewards utility instructs the microprocessor to create a save reward name and assign the save reward name to a child user. In some embodiments the assign rewards utility instructs the microprocessor to create a share reward name and assign the share reward name to a child user. In some embodiments the software program instructs the microprocessor to create a spend reward list comprising a spend reward name and a spend reward point value, where the spend reward point value is associated with the spend reward name, and to assign the spend reward list to the child user. In some embodiments the software program includes a reward purchase utility, where the reward purchase utility instructs the microprocessor to assign a share reward point value to the share reward name, subtract the share reward point value from the share points value, and add the share reward name to a rewards purchased list. In some embodiments the reward purchase utility further instructs the microprocessor to post the share reward name to a social networking site. In some embodiments the reward purchase utility instructs the microprocessor to assign a save reward point value to the save reward name, subtract the save reward point value from the save points value, and add the save reward name to a rewards purchased list. In some embodiments the reward purchase utility further instructs the microprocessor to post the save reward name to a social networking site.

A method of tracking job completion is disclosed which includes the steps of storing participant profile data, storing job data, storing reward data, crediting completion of a job, and purchasing a reward. In some embodiments participant profile data includes an earned points value, and a job list, wherein the job list comprises a job name. In some embodiments participant profile data includes a rewards purchased list, and a reward shopping cart list, where in the reward shopping cart list comprises a reward name.

In some embodiments the job data includes a job point value and a job completion indicator, wherein the job completion indicator indicates whether the job name has been completed or not. In some embodiments the reward data comprises a reward point value, wherein the reward point value is a number, and a reward purchase indicator, wherein the reward purchase indicator indicates whether purchase of the reward name is to be executed or not. In some embodiments crediting completion of a job comprises adding the job point value to the earned point value in response to the job completion indicator indicating that the job name has been completed. In some embodiments purchasing a reward comprises subtracting the reward point value from the earned point value, adding the reward name to the rewards purchased list, and removing the reward name from the reward shopping cart list in response to the reward purchase indicator indicating that purchase of the reward name is to be executed.

A computer-performed method of spending earned points is disclosed, where the method includes the steps of accumulating earned points into a points to organize value, and dividing the points to organize into a save points value, a share points value, and a spend points value. The method of spending earned points in a machine for tracking job completion includes the step of spending save points by purchasing a save reward, spending share points by purchasing a share reward, and spending spend points by purchasing a spend reward. In some embodiments spending save points means converting a requested amount of earned save points into a monetary value and putting this money aside into an account that accrues to the child's benefit. In some embodiments spending share points means converting a requested amount of earned share points into a monetary value and giving this money to a charity organization or other non-profit organization or cause. In some embodiments spending spend points means allowing the child to purchase items from the program's reward store using earned spend points. In some embodiments spending spend points means converting a requested amount of earned spend points into a monetary value—including cash or a cash equivalent—and allowing the child to purchase items outside the program's reward store. In some embodiments the method includes the step of converting a share points value to a monetary value. In some embodiments the method includes the step of converting a save points value to a monetary value. In some embodiments the method includes the step of converting a spend points value to a monetary value.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of one embodiment of machine 101 for tracking job completion according to the invention.

FIG. 2 is a block diagram of machine 101 for tracking job completion of FIG. 1.

FIG. 3 is a block diagram showing an embodiment of participant list 142 and participant profile data 120 which are part of software program 102 of machine 101 for tracking job completion.

FIG. 4 is a flow chart showing operation of one embodiment of job completion credit utility 160 which is part of software program 102 of machine 101 for tracking job completion of FIG. 1.

FIG. 5 is a block diagram showing participant list 142 and participant profile data 120 of FIG. 3 after job completion indicator 158 has been modified to reflect job completion, but before the job completion credit utility 160 has been executed.

FIG. 6 is a block diagram showing participant list 142 and participant profile data 120 of FIG. 5 after job completion credit utility 160 has been executed.

FIG. 7 is a flow chart showing operation of one embodiment of reward purchase utility 320 which is part of software program 102 of the machine 101 for tracking job completion of FIG. 1.

FIG. 8 is a block diagram showing participant list 142 and participant profile data 120 of FIG. 6 after reward purchase indicator 180 has been modified to request purchase execution, but before reward purchase utility 320 has been executed.

FIG. 9 is a block diagram showing participant list 142 and participant profile data 120 of FIG. 8 after reward purchase utility 320 has been executed.

FIG. 10 is one embodiment of user interface screen 163 created by the user interface utility of machine 101 for tracking job completion according to the invention. This user interface screen can be used by a participant to view job list 150 and record job completion.

FIG. 11 is another embodiment of user interface screen 163 created by the user interface utility of machine 101 for tracking job completion according to the invention. This user interface screen can be used by a participant to view reward shopping cart list 172 and purchase rewards.

FIG. 12 is a further embodiment of user interface screen 163 created by the user interface utility of machine 101 for tracking job completion according to the invention. This user interface screen can be used by an administrator to create participant list 142 and assign participant profile data 120 to participant name 144.

FIG. 13 shows method 300 of tracking job completion according to the invention.

FIG. 14 illustrates an embodiment of software program 102 of machine for tracking job completion 101 of FIG. 1 in which users 250 are divided up into family sets 252. Each family set 252 includes list of family members which comprises the user names 144 of those users that belong to the family set 252.

FIG. 15 shows how in some embodiments of software program 102 earned points 128 are accumulated as points to organize 228, and then divided up into save points 230, share points 232, and spend points 234.

FIG. 16 illustrates one embodiment of family member definition screen 258 created by some embodiments of software program 102 according to the invention, which allows definition of family member name 144, family member photo 122, and family member classification as either a parent user or a child user.

FIG. 17 illustrates one embodiment of family log-in screen 266 created by some embodiments of software program 102 according to the invention. Family member log-in screen 266 displays the names and/or photos of the family members that comprise the family set 252 the user belongs to, allows the user to select which family member name belongs to themselves, and log-in to software program 102.

FIG. 18 illustrates one embodiment of family dashboard screen 268 created by some embodiments of software program 102 according to the invention. Family dashboard screen 268 is presented to family members classified as parents.

FIG. 19 illustrates one embodiment of assign jobs screen 278 created by some embodiments of software program 102 according to the invention. Assign job screen 278 allows parent users to access and/or execute the assign jobs utility of software program 102.

FIG. 20 illustrates one embodiment of jobs summary screen 280 created by some embodiments of software program 102 according to the invention. Job summary screen 280 allows parent users to access and/or execute the assign jobs utility of software program 102.

FIG. 21 illustrates one embodiment of manage rewards screen 284 created by some embodiments of software program 102 according to the invention. Manage rewards screen 284 allows parent users to access and/or execute the assign rewards utility of software program 102.

FIG. 22 illustrates one embodiment of assign rewards screen 288 created by some embodiments of software program 102 according to the invention. Assign rewards screen 288 allows parent users to access and/or execute the assign rewards utility of software program 102.

FIG. 23 illustrates one embodiment of parent message board screen 290 created by some embodiments of software program 102 according to the invention. Parent message board screen 290 allows parent users to access and/or execute the parent send message utility of software program 102.

FIG. 24 illustrates one embodiment of job tracking screen 312 created by some embodiments of software program 102 according to the invention. Job tracking screen 284 allows child users to access and/or execute the job credit utility 160 and the child send message utility of software program 102.

FIG. 25 illustrates one embodiment of reward store screen 318 created by some embodiments of software program 102 according to the invention. Reward store screen 318 allows child users to access and/or execute the reward purchase utility 320 and the organize points utility of software program 102.

FIG. 26 illustrates one embodiment of organize points screen 322 created by some embodiments of software program 102 according to the invention. Organize points screen 322 allows child users to access and/or execute the organize points utility of software program 102.

FIG. 27 illustrates method 330 of spending earned points in one embodiment of machine 101 for tracking job completion of FIG. 1.

FIG. 28 shows one embodiment of account setting screen 201 created by some embodiments of software program 102. Account settings screen 201 is used by parent users to choose how the progress and goal completion of a child user is reported, including reporting to the parent user confidentially, using email or texting, or reporting progress to a social networking site.

### DETAILED DESCRIPTION OF EMBODIMENTS OF THE INVENTION

As discussed above, embodiments of the present invention relate to a machine for tracking job completion, also known as a job chart. In particular embodiments the invention forms an interactive job chart system incorporating task logging for children.

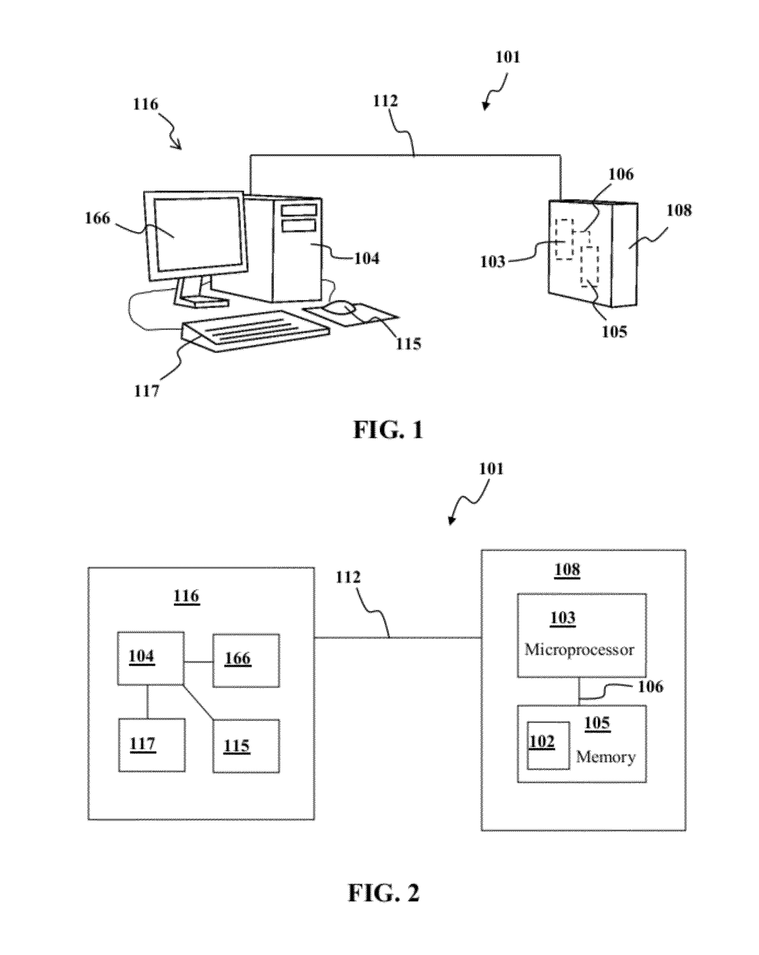

As shown in FIG. 1 and FIG. 2, the machine for tracking job completion 101 according to the invention includes microprocessor 103 coupled to memory 105. Machine for tracking job completion 101 includes software program 102 installed on memory 105 and operated using microprocessor 103. Memory 105 and microprocessor 103 are part of server 108 in this embodiment. In some embodiments memory 105 and microprocessor 103 are part of devices other than a server. Software program 102 includes a user interface utility coupled to input/output (I/O) device 116 through interconnect 112. I/O device 116 provides a means for users to interact with software program 102. Interacting with software program 102 includes providing input and viewing output from software program 102 as is true generally with software programs in use today. FIG. 1 shows a perspective view one embodiment of machine 101 according to the invention, and FIG. 2 shows one embodiment of a block diagram of machine 101 of FIG. 1. In the embodiment shown in FIG. 1, microprocessor 103 and memory 105 are part of server 108. I/O device 116 is coupled to server 108, and therefore to microprocessor 103, memory 105, and software program 102 through connection 112. I/O device 116 includes computer 104, monitor 166, keyboard 117, and mouse 115 in this embodiment. Microprocessor 103 and memory 105 are well adapted to be a part of an internet system and/or a cloud computer system.

The embodiment of machine 101 according to the invention shown in FIG. 1 and FIG. 2 illustrates a desktop computer as I/O device 116 connected via interconnect 112 to server 108. Interconnect 112 in this embodiment is an internet connection which is coupling I/O device 116 to server 108. In this way a user of software program 102 can interact with software program 102 by using a desktop computer as I/O device 116. Many other embodiments are possible of machine 101 according to the invention. In some embodiments microprocessor 103 and memory 105 can be part of a home computer such as a desktop or laptop computer. In some embodiments microprocessor 103 and memory 105 can be part of a mobile computer. In some embodiments microprocessor 103 and memory 105 can be part of a mobile phone such as a cellular phone. In some embodiments microprocessor 103 and memory 105 can be part of a personal digital assistant (PDA) or a smart phone or any type of mobile device. In some embodiments microprocessor 103 and memory 105 can be part of an Apple™ device such as an iPhone, an iPod, or an iPad, for example but not by way of limitation. In some embodiments microprocessor 103 and memory 105 can be part of another device capable of coupling microprocessor 103 and memory 105 to connection 112. In some embodiments connection 112 is an internet connection. In some embodiments connection 112 is a network connection such as a local area network or a wireless area network. In some embodiment connection 112 is a Bluetooth connection. In some embodiments connection 112 is a USB cable or a monitor interface cable. In some embodiments connection 112 is a cellular phone network. In some embodiments connection 112 is a hard-wired connection. In some embodiments connection 112 is a wireless connection. In some embodiments connection 112 is another means for coupling a computer to an input device. In some embodiments connection 112 is another means for coupling a computer to an output device.

I/O device 116 can take many different forms according to the invention. As shown in FIG. 1, I/O device 116 can be a computer connected to the internet. In some embodiments I/O device 116 is a monitor and a keyboard and a mouse. In some embodiments I/O device 116 is a monitor. In some embodiments I/O device 116 is a keyboard. In some embodiments I/O device 116 includes a touch device. In some embodiments I/O device 116 is a cellular phone. In some embodiments I/O device 116 includes a digital camera. In some embodiments I/O device 116 is a personal digital assistant. In some embodiments I/O device 116 is an Apple™ device such as an iPhone, an iPod, or an iPad, for example but not by way of limitation. In some embodiments I/O device 116 is any device adapted to interface with a computer. In some embodiments I/O device 116 is any device adapted to interface with a network.

Machine 101 according to the invention is used to track completion of jobs. Software program 102 of machine 101 is used to create a list of participants. Participants are assigned jobs to perform. An administrator creates participant lists and assigns participant profile data to each participant name. The administrator or administrators assigns jobs, and in general sets up software program 102. Administrators set goals for the participants, which the participant users earn rewards for achieving. Participants view the jobs they are assigned, record completion of the jobs, earn points for job completion, and trade the points for rewards. The participant earns reward points for completing the goals that have been set by the administrator. In some embodiments the reward point values are converted to a monetary value. In some embodiments rewards are ‘purchased’ with reward points that do not correspond to a monetary value. In the embodiment of machine 101 described in this document, the participants are child users and the administrator or administrators are parent users. This embodiment will be discussed in more detail throughout this document. It is to be understood, however, that in some embodiments participants are users other than children and administrators are users other than parents. In some embodiments administrators are family members other than parents. In some embodiments participants are students and administrators are teachers. In some embodiments participants are disabled children or adults, and the administrator is a caretaker. In some embodiments participants are Sunday school children and the administrator is a Sunday school teacher. Many different forms are possible for machine 101 for tracking job completion.

Machine for tracking job completion 101 is used in the embodiment described in this document as an efficient means for parents to assign jobs to children in order to build work ethic, to teach responsibility and to communicate with their children using technology and positive reinforcement. The parent or guardian registers their child as a child user on machine for tracking job completion 101 using software program 102 and create an individualized profile for the child(ren). The parent or guardian inputs jobs to be assigned to the child through his/her profile within the framework of software program 102, according to the age and ability of the child. Jobs may be assigned a value on a point system that may be traded for rewards.

The child logs onto software program 102 each day to view the assigned jobs and log completion of the jobs. During the process the child may be encouraged in these jobs by the parent sending personalized notes of encouragement which can be accessed from a computer, cellular phone or PDA. The child completes the jobs and as each job is completed the child records job completion and accumulates the assigned point values. Upon successful completion of jobs or reward redemption a message may be sent to the parent's cellular phone or computer in the form of an email or text message.

The accumulated points may be traded for rewards that may include family time, movie nights, computer time, game time and other such rewards. The parent and child can determine what rewards that the child wants to work towards. When a reward is claimed, the points are deducted on the points accumulation display to coincide with the redemption. In some embodiments reward points can be converted to a monetary value, and the child can use the monetary value to make a deposit to a bank account, contribute to charity, or purchase store items. The reward store may be linked to Amazon.com, ebay, itunes, gift card venders, or other such sites to redeem products. Target marketing may also be utilized within the reward store based upon the age and gender of the child.

In some embodiments, machine for tracking job completion 10 is linked to social networking sites such as Facebook, Twitter, or other social networking sites. Goals, rewards, and progress can be posted to the social networking sites as desired by the parent user or the child user so that child users can share their progress and rewards. In some situations rewards can include time interacting with electronic computing and socializing devices. For examples, rewards can be time spent on a computer; time spent playing computer games, time spent on a particular social network site, or other event which is motivational for the child or other participant.

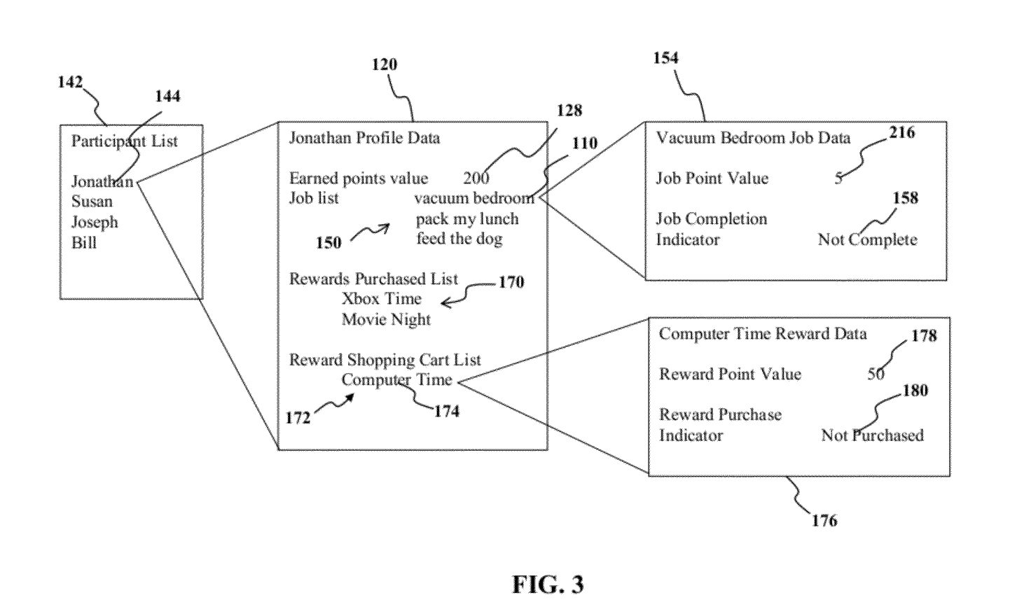

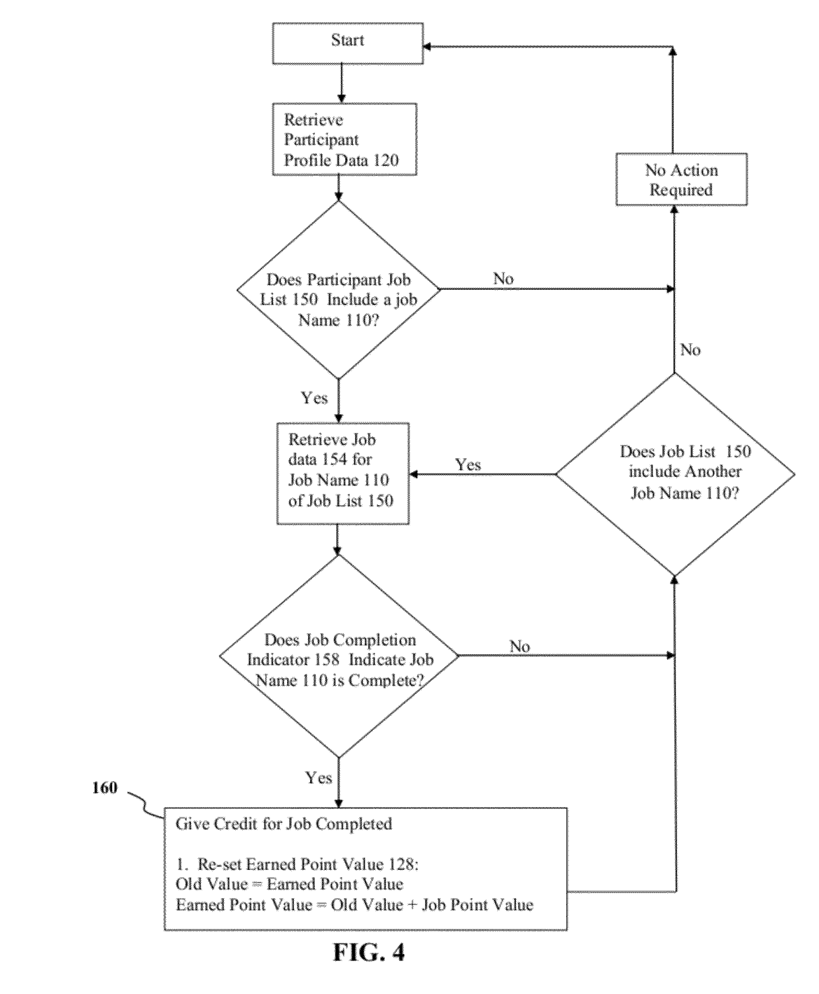

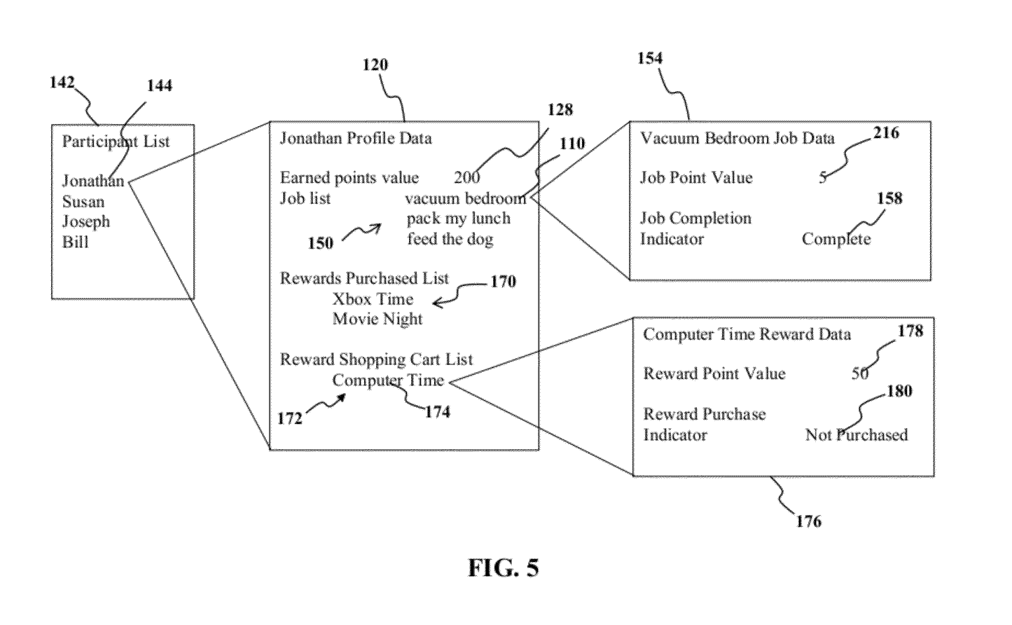

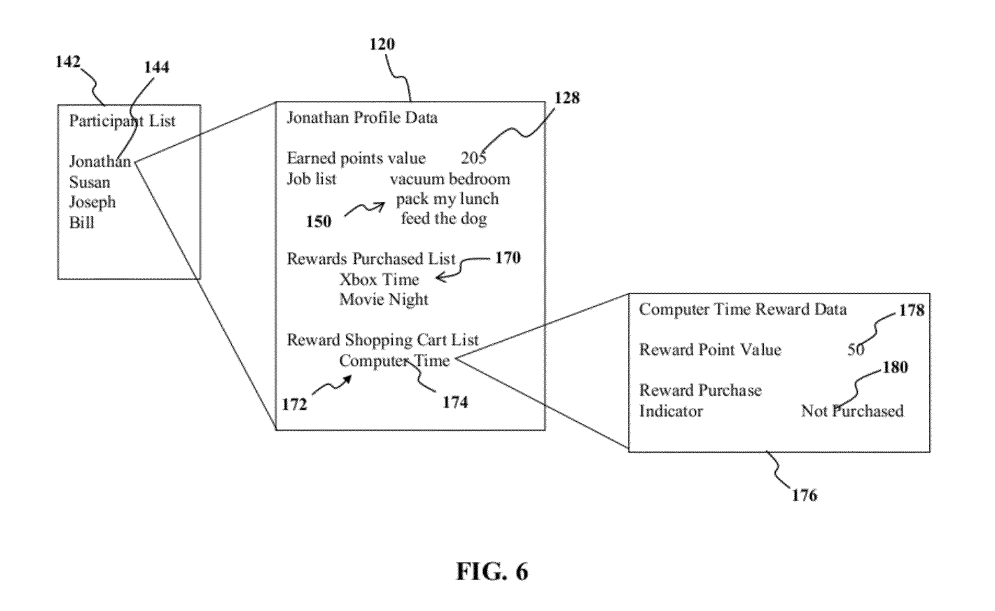

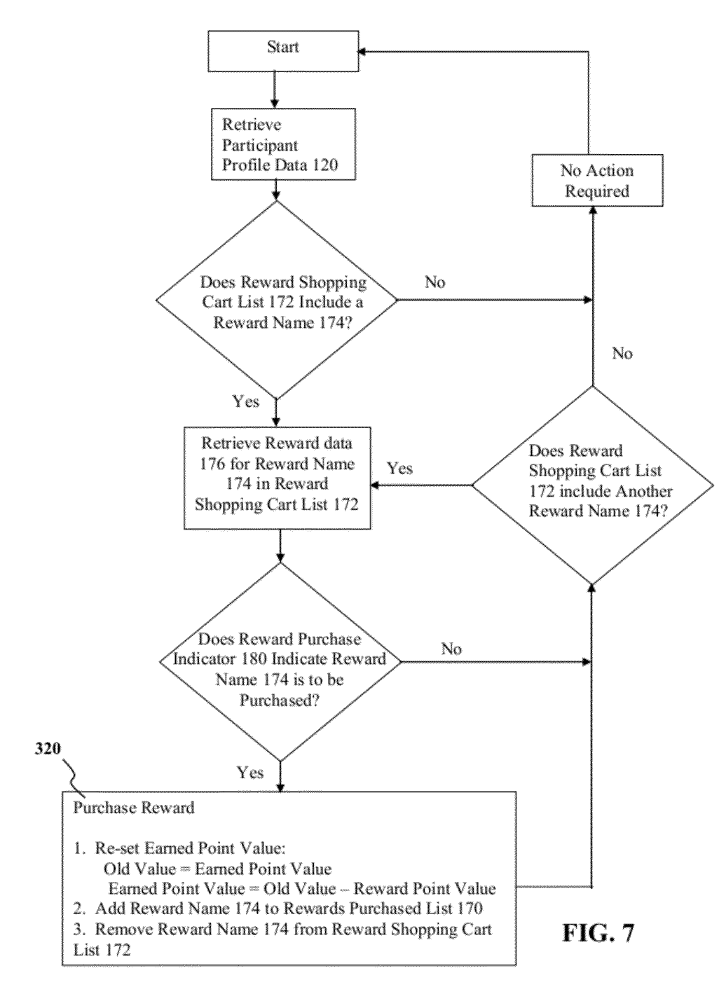

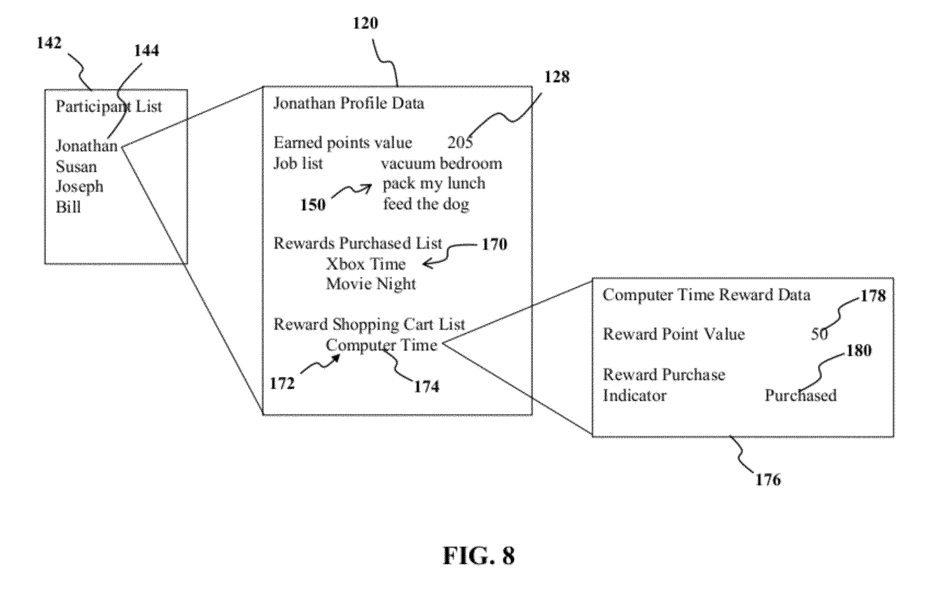

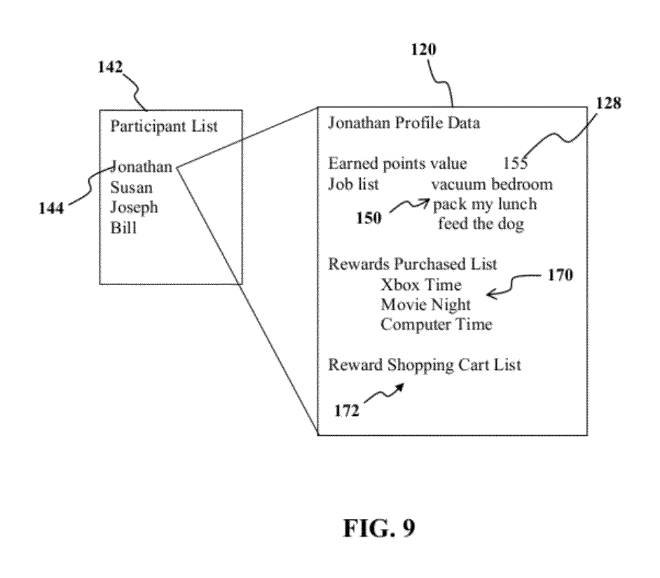

FIG. 3 through FIG. 9 show details of the operation of an embodiment of software program 102 according to the invention. FIG. 3 is a block diagram showing a snapshot of some of the data stored as participant profile data 120 as created and used by software program 102 in this embodiment. FIG. 4 is a flowchart including job completion credit utility 160, which is part of software program 102. FIG. 5 is the data of FIG. 3 after job completion indicator 158 has been modified to indicate a job name is complete. FIG. 6 is the data of FIG. 5 after job completion utility 160 has been executed to give the participant credit for completion of the job. FIG. 7 is a flowchart including reward purchase utility 320, which is part of software program 102. FIG. 8 is the data of FIG. 6 after purchase indicator 180 has been modified to indicate purchase of the reward name is to be executed. FIG. 9 is the data of FIG. 8 after reward purchase utility 320 has been executed to purchase the reward name for the participant.

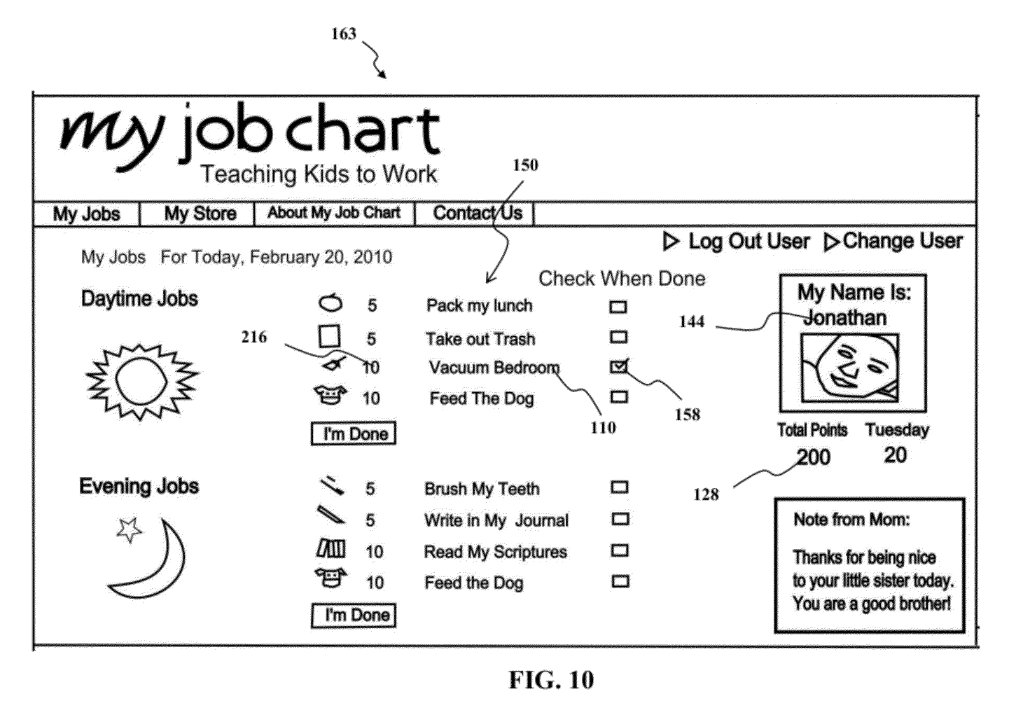

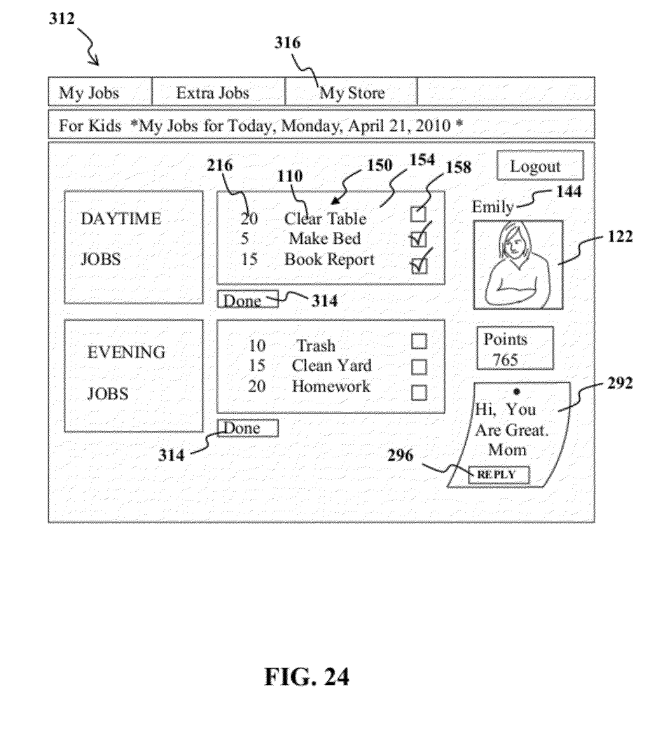

Software program 102 includes participant list 142 as shown in FIG. 3. Participant list 142 includes a participant name 144. This means that participant list 142 includes one or more than one user name 144, where the user name designates a child (participant) user. In this embodiment the participant names are names of children that are entered by a parent. Participant list 142 as shown in FIG. 3 includes participant name 144 corresponding to child user “Jonathan”. Software program 102 includes participant profile data 120. Participant profile data 120 includes data assigned to participant name 144 Jonathan. Participant profile data 120 includes an earned point value 128. Earned points value 128 is a number which represents the number of points that Jonathan has earned so far. In this embodiment Jonathan has an earned point value 128 that is equal to 200 points. Participant profile data 120 also includes a job list 150. Job list 150 is a list of jobs that have been assigned to Jonathan by his parent. Job list 150 includes a job name. This means that job list 120 includes one or more than one job name. Job list 150 in this embodiment includes job name 110 “vacuum bedroom”. Job name 110 has job data 154 assigned to it by software program 102. Job data 154 includes job point value 216 and job completion indicator 158. Job point value 216 is a number which is the number of points that Jonathan will earn if he completes job name 110 “vacuum bedroom”. In this embodiment job point value 216 for job name 110 vacuum bedroom is equal to 5 points. This means that Jonathan will earn 5 points when he completes and records completion of job name 110 vacuum bedroom. Job completion indicator 158 is an indicator which can be in one of two states. One state represents that the job is not complete. The other state represents that the job is complete. In this way job completion indicator 158 indicates whether a job has been completed or not. Jonathan utilizes a user interface utility which is part of software program 102 to interface to software program 102. FIG. 10 shows one embodiment of a user interface screen 163 created by the user interface utility and interacted with by Jonathan using keyboard 117 and mouse 115. FIG. 24 through FIG. 26 show additional embodiments of user interface screens used by child user Jonathan to interact with software program 102. In this way Jonathan not only learns to track and complete jobs and earn points, he is also learning to use and interact with a computer program. Jonathan sees that his job list 150 includes job name 110 vacuum bedroom. Jonathan goes off to vacuum his bedroom. Then Jonathan modifies job completion indicator 158 to indicate that job name 110 vacuum bedroom is complete.

Software program 102 includes job completion credit utility 160. Job completion credit utility 160 can be invoked by a child user of software program 102 after a job completion indicator 158 is changed to indicate a job is complete, as shown by the flow chart in FIG. 4. Software program 102 monitors participant profile data 120 assigned to each participant name 144. When job completion indicator 158 for job name 110 on job list 150 indicates that a job has been completed, job completion credit utility 160 adds job point value 216 to earned points value 128. For example, FIG. 3 indicates the status of some of the data in participant profile data 120 for participant name 144 Jonathan before he has completed job name 110 vacuum bedroom. Job completion indicator 158 for vacuum bedroom indicates the job is not complete. Jonathan has an earned points value 128 of 200 points and can earn 5 more points for vacuuming his bedroom. FIG. 5 shows the status of data in participant profile data 120 for participant name 144 Jonathan after Jonathan has completed job name 110 vacuum bedroom but before he has executed job completion credit utility 160 to give him credit for the job. Job completion indicator 158 indicates job 110 vacuum bedroom has been completed. FIG. 6 shows the status of data in participant profile data 120 for Jonathan after the job completion credit utility 160 has given Jonathan credit for job name 110 vacuum bedroom. Earned points value 128 is now equal to 205 points after job point value 5 for job name 110 vacuum bedroom was added to the old earned points value of 200 points. Jonathan has completed the job vacuuming his bedroom and has received credit points for doing this job. In this way job completion credit utility 160 adds job point value 216 to earned point value 128 in response to job completion indicator 180 indicating that job name 110 is complete. In some embodiments the steps performed in response to job completion indicator 158 indicating the job is complete includes sending an email to a predetermined email address to report job completion. In some embodiments the steps performed in response to job completion indicator 158 indicating the job is complete includes sending a text message to a predetermined mobile device to report job completion. In some embodiments the steps performed in response to job completion indicator 158 indicating the job is complete includes sending a text message to a predetermined cellular phone number to report job completion. In this way machine 101 for tracking job completion shows Jonathan clearly how completing jobs results in his earned point value 128 increasing. There is a relationship between doing a job and earning points for completion of the job. In some embodiments of the invention the parent can communicate an encouraging message to Jonathan as another reward received for job completion. FIG. 4 shows one embodiment of job credit utility 160 as used by software program 102. Many other embodiments of job credit utility 160 are possible according to the invention. Software program 102 can use job credit utility 160 in ways other than that shown in FIG. 3 through FIG. 6.

Software program 102 stored on memory 102 has instructed microprocessor 103 to track job completion of Jonathan's job by performing certain steps. These steps include storing participant profile data 120 assigned to participant name 144. Participant profile data 120 includes earned points value 128 and job list 150 which includes job name 110. The steps microprocessor 103 is instructed to perform by software program 102 includes storing job data 154 assigned to job name 110. Job data 154 includes job point value 216 and job completion indicator 158. A further step microprocessor 103 is instructed to perform by software program 102 is crediting completion of job name 110 in response to job name 110 having job completion indicator 158 indicate that job name 110 is complete. Crediting completion of job name 110 includes the step of adding job point value 216 to earned point value 128. In some embodiments crediting completion of job name 110 includes the step of sending an email to a predetermined email address reporting completion of job name 110.

Software program 102 allows Jonathan, as the child user, to purchase rewards using the points he has earned completing jobs. As illustrated in FIG. 6, participant profile data 120 for Jonathan includes rewards purchased list 170. Rewards purchased list 170 is a list of all of the rewards Jonathan has purchased already. Participant profile data 120 also includes reward shopping cart list 172. Reward shopping cart list 172 includes a reward name 174. Reward shopping cart list 172 is a list of the rewards Jonathan is considering purchasing, and can include one or more than one reward name. In this embodiment reward shopping cart list 172 contains reward name 174 “computer time”. Reward name 174 computer time has reward data 176 assigned to it. Reward data 176 includes reward point value 178. Reward point value 178 is the number of points needed to purchase the computer time reward. In this embodiment reward point value 178 for computer time is 50 points. Reward data 176 also includes reward purchase indicator 180 which indicates whether purchase of reward name 174 is to be executed or not. Reward purchase indicator 180 can have one of two states. One state indicates that purchase of reward name 174 is not to be executed, which is state “not purchased”. The other state indicates that the purchase of reward name 174 is to be executed, which is state “purchased”. Jonathan can add reward names to his reward shopping cart list 172, but purchase of them will not be executed until Jonathan modifies reward purchase indicator 180 for a reward name 174 from “not purchased” to “purchased”.

Software program 102 includes reward purchase utility 320. Reward purchase utility 320 is invoked by a child user of software program 102 after reward purchase indicator 180 is changed to indicate purchase of reward name 174 is to be executed, as shown in the flowchart of FIG. 7. Software program 102 monitors participant profile data 120 for each participant name 144. When reward purchase indicator 180 for a reward name on reward shopping cart list 172 indicates that a reward purchase is to be executed, reward purchase utility 320 performs several steps, as shown in FIG. 7. These steps include subtracting reward point value 178 from earned point value 128, adding reward name 174 to rewards purchased list 170, and removing reward name 174 from reward shopping cart list 172. For example, FIG. 6 indicates the status of some of the data in participant profile 120 for participant Jonathan before he has executed the purchase of reward name 174 “computer time”. Reward purchase indicator 180 for computer time indicates that the purchase is not to be executed. Jonathan has an earned points value 128 of 205 points and it will cost him 50 points to purchase computer time 174. FIG. 8 shows the status of the data in participant profile data 120 for participant Jonathan after he has decided to execute the purchase of reward name 174 computer time but before reward purchase utility 320 has executed his purchase. Reward purchase indicator 180 indicates purchase of reward 110 computer time is to be executed. FIG. 9 shows the status of some of the data in participant profile data 120 for Jonathan after reward purchase utility 320 has executed purchase of reward name 174 computer time. Earned point value 128 is now equal to 155 points after reward point value 178, which is worth 50 points for reward name 174 computer time, was subtracted from the old earned point value 128 of 205 points. Reward name 174 computer time has been added to rewards purchased list 170. And reward name 174 computer time has been removed from reward shopping cart list 172. Jonathan has completed purchase of reward name 174 computer time using 50 of his earned points. In this way machine 101 for tracking job completion has taught Jonathan how to earn and use points. In this way reward purchase utility 320 places reward name 174 on rewards purchase list 170, removes reward name 174 from reward shopping cart list 172, and subtracts reward point value 178 from earned point value 128 in response to reward purchase indicator 180 indicating that purchase of reward name 174 is to be executed. In some embodiments the steps performed by reward purchase utility 320 in response to reward purchase indictor 180 indicating reward name 174 computer time is to be purchased includes sending an email to a predetermined email address to report purchase of reward name 174. In this way purchase of the reward will be reported to Jonathan's parent. FIG. 7 shows one embodiment of reward purchase utility 320 as used by software program 102. Many other embodiments of reward purchase utility 320 are possible according to the invention. Software program 102 can use reward purchase utility 320 in ways other than that shown in FIG. 6 through FIG. 9.

Software program 102 stored on memory 102 has instructed microprocessor 103 to purchase rewards by Jonathan by performing the steps of storing participant profile data 120 assigned to participant name 144, wherein participant profile data 120 includes rewards purchase list 170 and reward shopping cart list 172. Reward shopping cart list 172 includes reward name 174. The steps further include storing reward data 176 assigned to reward name 174. Reward data 176 includes reward point value 178 and reward purchase indicator 180. Microprocessor 103 is instructed by software 102 to perform purchasing of a reward by performing several steps in response to reward purchase indicator 180 indicating that reward name 174 is to be purchased. These steps include subtracting reward point value 178 from earned point value 128, adding reward name 174 to rewards purchased list 170, and removing reward name 174 from reward shopping cart list 172. In some embodiments of software program 102 the steps microprocessor 103 is instructed to perform in response to reward purchase indicator 180 indicating reward name 174 is to be purchased includes sending an email to a predetermined email address to report purchase of reward name 174.

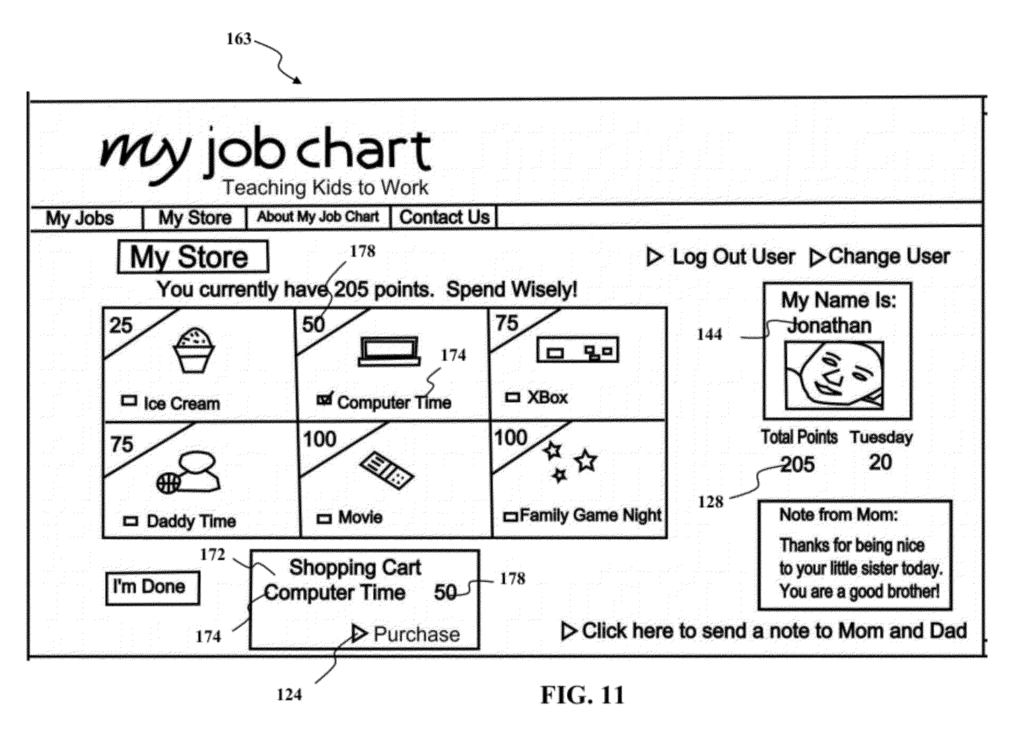

FIG. 11 shows one embodiment of user interface image 163 created by the user interface utility of software program 102 and displayed on output device 166. User interface image 163 is interacted with by participant Jonathan using keyboard 117 and mouse 115 (see FIG. 1). In some embodiments participants interact with software program 102 using other interface devices. Jonathan can see that he has 205 earned points, and can view the list of rewards that are available for purchase. Each reward name 174 has a corresponding reward point value 178. Jonathan can add reward names to his reward shopping cart list 172, and change reward purchase indicator 180 from “not purchased” to “purchased” using icon 124 when he is ready to execute purchase of a reward name 174. The rewards on Jonathan's reward list are chosen by an administrator, in this embodiment Jonathan's parent. The parent can assign rewards to the reward list appropriate for Jonathan's age, gender, abilities, interests, and personality. The parent also defines how many points to assign to each reward name 174. In this way Jonathan is able to work to earn rewards he values and to see the tangible results of his work.

Jonathan is able to view and interface with some, but not all, of his participant user profile data 120. Jonathan is not able to assign himself jobs or add his name to the participant list, or assign job point values 216 to his jobs. Jonathan is not able to create rewards or add rewards to the rewards he has available to purchase, or to assign reward point values 178 to the rewards. Only his parent, the administrator, is allowed to modify this data. Jonathan can see his job list 150 (FIG. 10), record job completion, and purchase rewards from a reward list. Jonathan is allowed to use job credit utility 160 and reward purchase utility 320. Software program 102 uses microprocessor 103 to provide a participant interface utility which creates user interface images 163 such as those shown in FIG. 10 and FIG. 11 to allow Jonathan to interface with software program 102 and interact with some of his participant profile data 120. In this way software program 102 instructs microprocessor 103 to provide a participant interface tool which allows Jonathan access to predetermined parts of his participant profile data 120.

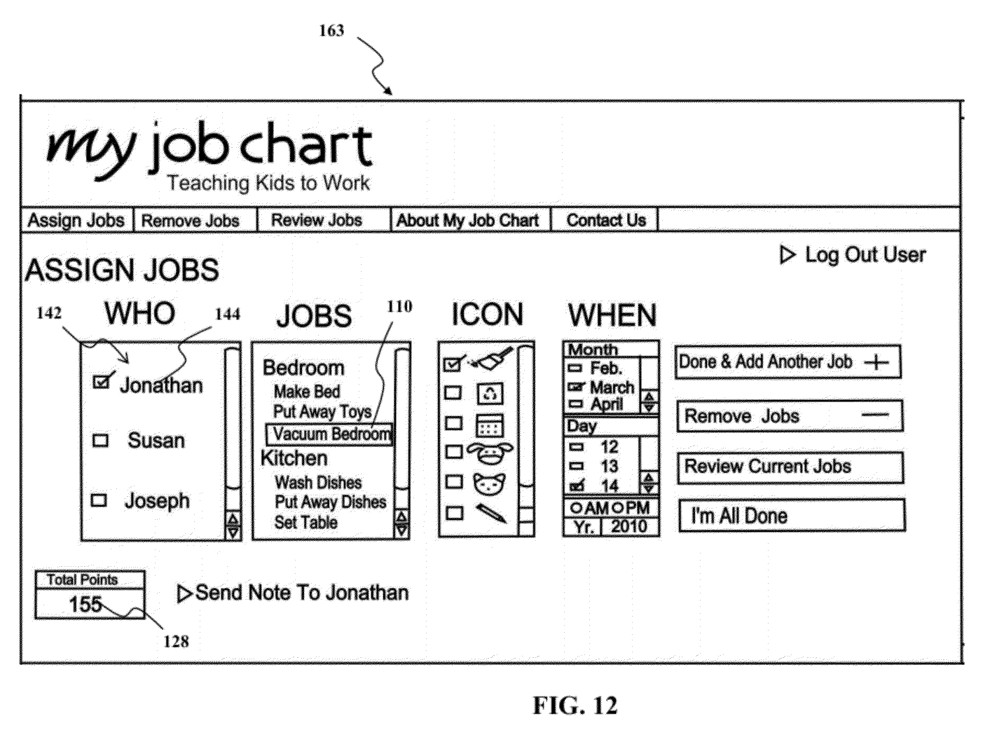

FIG. 12 shows an embodiment of user interface image 163 created by the user interface utility of software program 102 for allowing an administrator/parent user to interface with participant profile data 120. An administrator, in this embodiment Jonathan's parent, is able to create participant list 142, create participant names 144, and create and modify participant profile data 120 for those users which belong to the family of the parent user. In this way software program 102 instructs microprocessor 103 to provide an administrator interface tool which allows Jonathan's parent to define participant names, and create and interact with all of participant profile data 120 belonging to the child users that are members of the parent user's family.

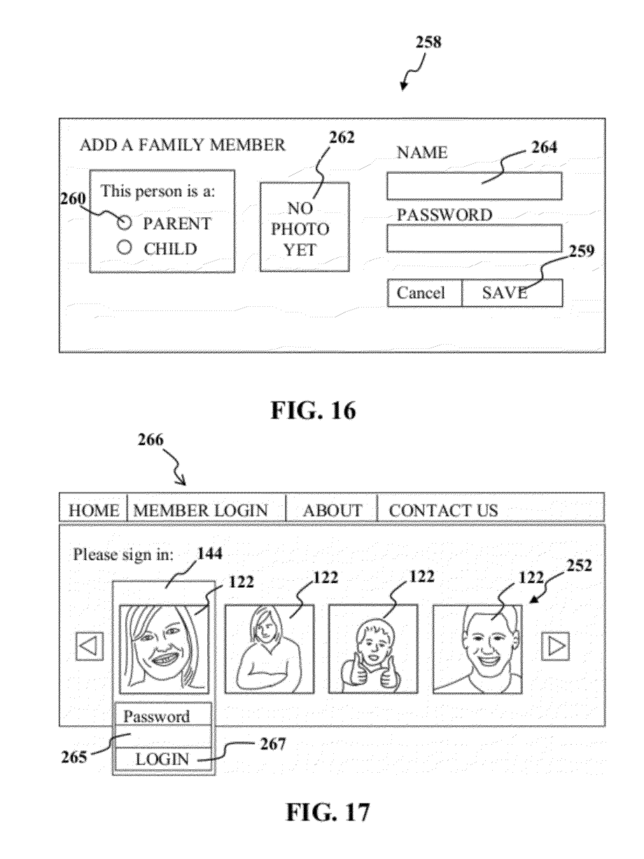

It is to be understood that many other forms of user interface image 163 are possible. Image can be created in many forms and used by participants or administrators to interact with software program 102. In some embodiments user interface image 163 can include motivational and informational images for Jonathan. FIG. 16 through FIG. 26 show additional embodiments of user interface screen created by embodiments of software program 102 according to the invention. These user interface images will be discussed shortly.

In some embodiments machine 101 with software program 102 according to the invention includes a job calendar utility. The job calendar utility can be programmed by the administrator or parent to add job names to a participant job list 150 according to a certain calendar schedule. For example, Jonathan's parent can set the job calendar utility to add the job name “brush teeth” to Jonathan's job list 150 every day. There may be other jobs that Jonathan needs to do daily, such as feed the dog, which can also be added to Jonathan's list on a daily basis. Other jobs, such as vacuum bedroom, might only need to be done every week. Jonathan's parents can use the job calendar utility to have the job name 110 vacuum bedroom be added to Jonathan's job list 150 every week. There may be other jobs which only have to be done monthly, or every few months. The job calendar utility allows jobs to be added to job lists according to a calendar schedule specific to each job name. In this way software program 102 includes a job calendar utility which adds job names 110 to job list 150 according to a predetermined calendar schedule.

In some embodiments of software program 102, job data 154 includes a job due date. The job due date is the date and time job name 110 is to be completed by. The job due date will help Jonathan know how much time he has to complete a job. In some embodiments of the invention, Jonathan can earn bonus points, which are added to earned point value 128, by completing a job a predetermined amount of time before the due date. For example, the job vacuum bedroom might have a due date of one week. If Jonathan finishes vacuuming his bedroom in one week he will earn 5 points. But, Jonathan's parent can set up software program 102 such that for each day early that Jonathan completes vacuuming his bedroom, he will earn 1 extra point. So if Jonathan completes vacuuming his bedroom 2 days early, he can earn 7 points (5 points for job completion, 2 points for completed 2 days early). In this way bonus points are added to earned point value 128 in response to job completion occurring a predetermined amount of time before the job due date. In some embodiments of software program 102, bonus points are earned by a participant by completing a predetermined number of tasks within a predetermined amount of time. In some embodiments bonus points are earned when earned point value 128 reaches a predetermined number.

In some embodiments of software program 102, the job due date can be used to penalize Jonathan for jobs completed late. Continuing the further example, the job vacuum bedroom can be set up by Jonathan's parent using software program 102 so that for every day he is late in completing the job, he loses 1 earned point value. In this way Jonathan learns not only that he can earn value by completing jobs, but that there is a penalty for not completing jobs on time. This teaches scheduling and prioritizing skills. In this way penalty points are subtracted from the earned points value in response to completion occurring after the job due date.

In some embodiments of software program 102 earned point value 128 can be converted to a monetary amount. The participant can be provided choices as to what they would like to do with the monetary amount. The choices can include making a deposit to a bank or other financial institution, contributing to a charity or church, or making a purchase of store items. In some embodiments the rewards list can be linked to store websites so that participants can choose store products as rewards. Many other choices can be provided as to what to do with reward points or monetary amounts depending on the specific participant. In some embodiments the participant can choose to invest a monetary amount. In some embodiments the monetary amount can be used for a college fund or for paying bills. It is to be understood, however, that in some embodiments the earned point value does not correspond to a monetary amount, and the rewards purchased do not correspond to commercial items. In the embodiment discussed in this document, Jonathan is learning the value of working to accomplish a reward. But he is also learning that money is not always what is earned, and that money is not always what is important, and that some rewards cannot be bought with money. Jonathan and his parent create a reward list for Jonathan that allows Jonathan to earn items that are important to him, such as time playing a sport, family time, or a chance to take a trip to a favorite place. In this way earned reward points can be, but are not always, related to monetary values and rewards purchased are not always commercial items purchased with money. Software program 102 allows the jobs performed, and the rewards purchased to be customized to the needs of the participant. In some situations earned reward points are converted into monetary values, and in some situations earned points are not converted into monetary values.

In some embodiments of software program 102 job data 154 can include information helpful to job completion, such as the location of cleaning products, instructions on how to use cleaning machines, or encouraging notes from an administrator. In this way Jonathan's parents can provide information and encouragement for Jonathan to use in completing his jobs. In some embodiments of software program 102 participants and administrators can send secure messages back and forth. Jonathan may want to ask questions of his parent. The parent may want to encourage or thank Jonathan. In this way program 102 provides secure communication means between a participant and an administrator.

It is to be understood that many different I/O devices 116 can be a part of machine 101 for tracking job completion. I/O device 116 can be or include any computer, keyboard, mouse, touch screen, pointer, Wii device, digital camera, cellphone, PDA, or any other computing or communication device. This allows participants and administrators to interact with machine 101 and each other from local or remote locations, at school, at home, at work, while traveling, etc.

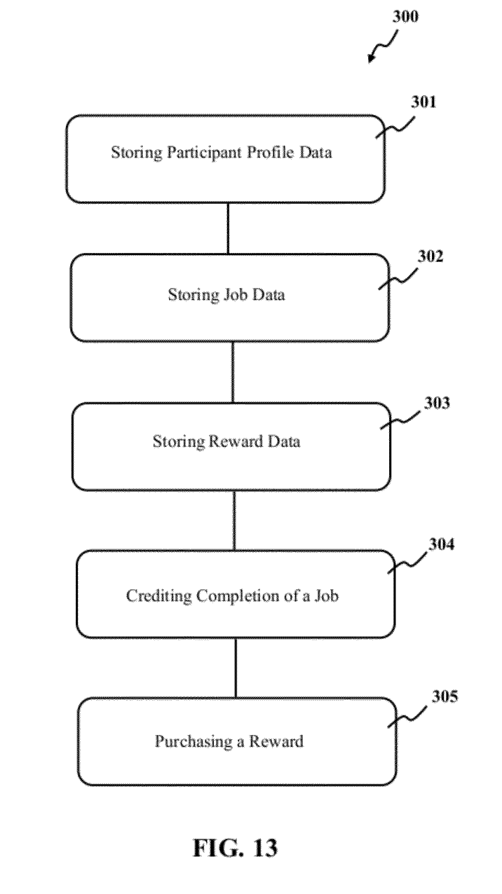

FIG. 13 illustrates a computer performed method 300 of tracking job completion according to the invention which includes step 301 storing participant profile data, step 302 storing job data, step 303 storing reward data, step 304 crediting completion of a job, and step 305 purchasing a reward. Method 300 can include many other steps. In some embodiments method 300 includes the step of providing a participant interface tool which allows a participant access to predetermined portions of the participant profile data. In some embodiments method 300 includes the step of providing an administrator interface tool which allows an administrator to define a participant name and allows an administrator access to all of the participant profile data.

Step 301 storing participant profile data includes storing participant profile data assigned to a participant name. The participant profile data includes an earned points value which is a number representing the number of points earned by the participant name. The participant profile data includes a job list, wherein the job list includes a job name. The participant profile data includes a rewards purchased list and a reward shopping cart list. The reward shopping cart list can contain a reward name.

Step 302 storing job data includes storing job data assigned to the job name. The job data includes a job point value, which is a number representing the number of points earned by completing the job name. The job data includes a job completion indicator, which indicates whether the job name has been completed or not completed. In some embodiments storing job data includes storing preferences included in a job summary. In some embodiments storing job data includes storing how job completion is to be reported, such as to a parent only, or to a social networking site.

Step 303 storing reward data includes storing data assigned to the reward name. The reward data includes a reward point value, which is a number representing the number of points needed to purchase the reward name. The reward data also includes a reward purchase indicator, which indicates whether purchase of the reward name is to be executed or not.

Step 304 crediting completion of a job includes adding the job point value to the earned point value in response to the job completion indicator indicating that the job name has been completed. In some embodiments step 304 includes sending an email to a predetermined email address to report job completion. In some embodiments step 304 includes sending a text message to a predetermined mobile device to report job completion. In some embodiments step 304 includes sending a text message to a predetermined cellular phone to report job completion. In some embodiments step 304 includes posting a message to a predetermined social networking site to report job completion and/or save, spend and share accomplishments.

Step 305 purchasing a reward includes subtracting the reward point value from the earned point value, adding the reward name to the rewards purchased list, and removing the reward name from the reward shopping cart list in response to the reward purchase indicator indicating that purchase of the reward name is to be executed. In some embodiments step 305 includes sending an email to a predetermined email address to report purchase of the reward name.

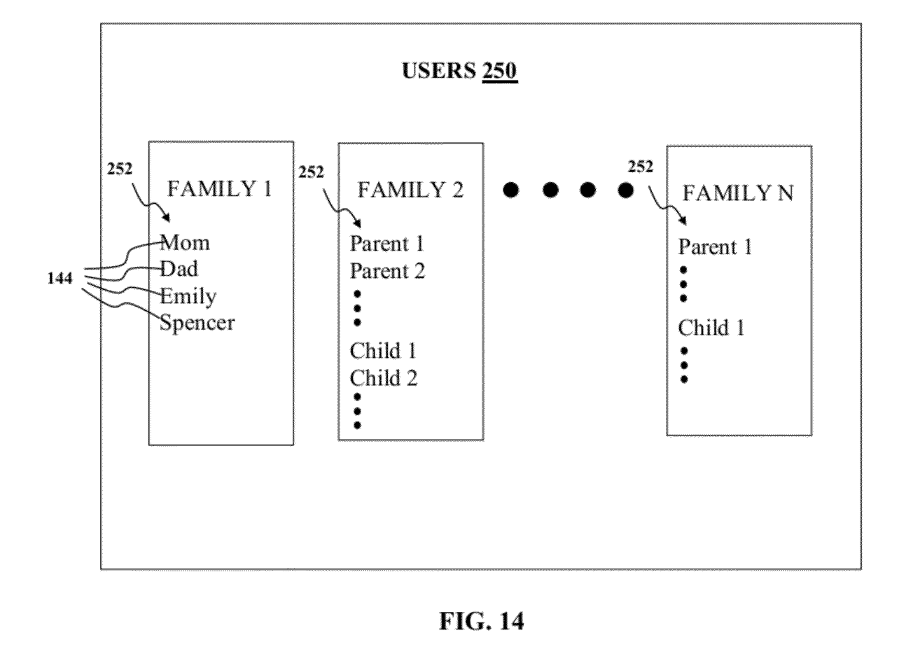

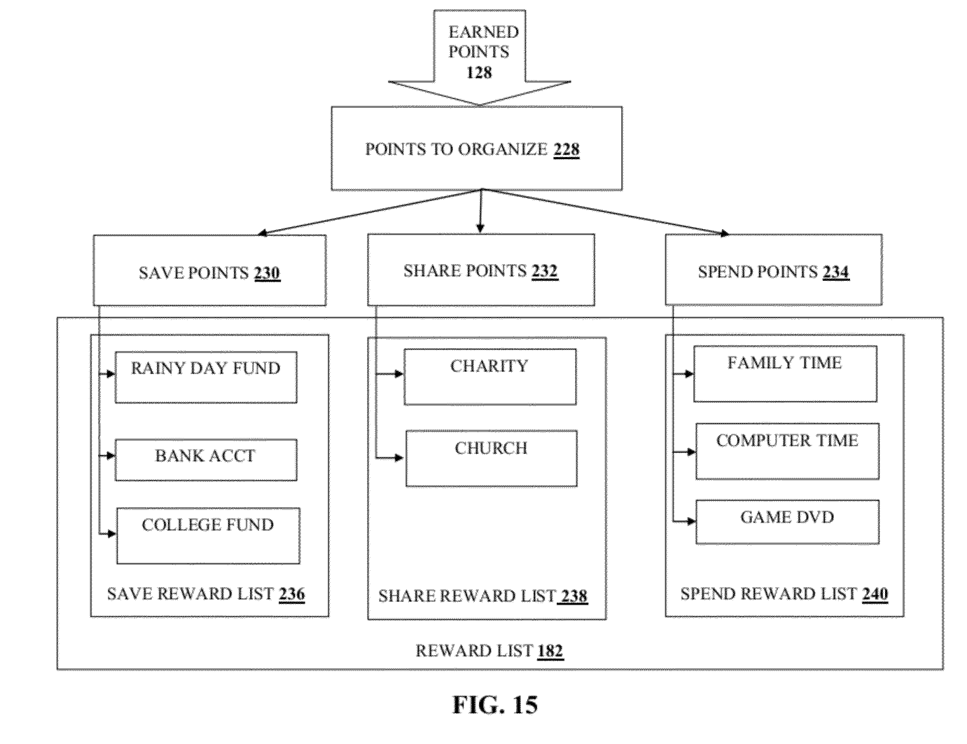

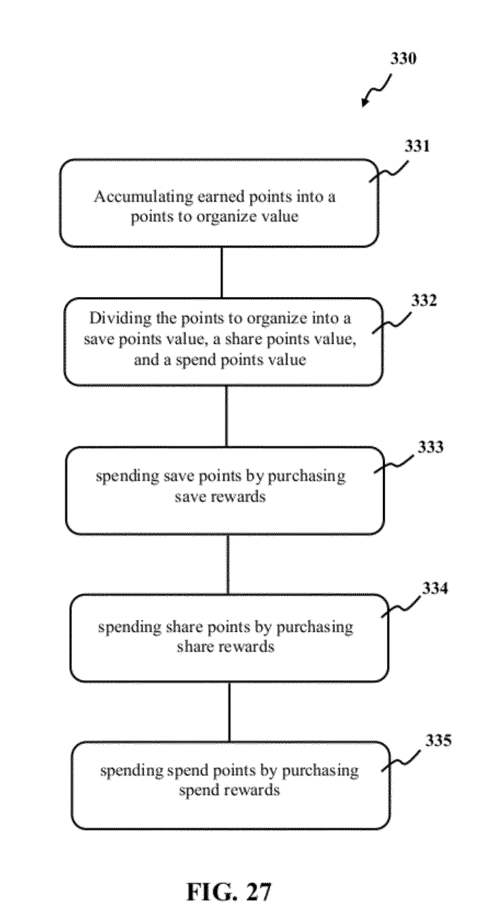

FIG. 14 through FIG. 27 illustrate additional features that exist in some embodiments of software program 102 of machine for tracking job completion 101 according to the invention. FIG. 14 is a block diagram illustrating an embodiment in which users 250 of software program 102 of machine for tracking job completion 101 are divided up into family sets 252. FIG. 15 illustrates how in the embodiment of software program 102 shown in FIG. 14, points earned by child users for completing jobs are divided up into three categories, save points 230, share points 232, and spend points 234 prior to purchasing rewards. FIG. 16 through FIG. 26 show some of the user interface screens created by the embodiment of software 102 of FIG. 14 to allow users 250 to interface with software 102. FIG. 27 illustrates computerized method 330 of spending earned reward points in a machine for tracking job completion according to the invention.

FIG. 14 shows in block diagram form an embodiment of software 102 in which users 250 of software 102 of machine for tracking job completion 101 are divided up into groups of family members using a family definition utility of software program 102 according to the invention. Each group of family members includes list of family names 252, where list of family names 252 is a list of the names 144 or photos 122 of the users that belong to that particular family. The list of family names 252 is called a family set 252. In this embodiment users are classified as either administrators, called parents or parent users in this embodiment, or participants, also called children, or child users in this embodiment. Each family set 252 has at least one parent user and at least one child user. A software user cannot be classified as both a parent user and a child user. Parents create and control the family information and participant/child profiles 120, and children use software program 102 to track completion of their jobs and purchase rewards. The family definition utility of software program 102 allows parents/administrators to create a family set 252, populate the family with family member users, and classify the family members as either parents or children. Software program 102 allows each family member to log into software program 102 and presents each family member with the different program utilities they are allowed to use, depending on whether the family member is a parent user or a child user. Software 102 allows parent users to access and use an assign jobs utility, a manage rewards utility, a family member definition utility, and a parent send message utility, among other utilities. Software 102 allows child users to access and use job tracking utility 160 and reward purchase utility 320 as explained earlier, as well as an organize points utility and a child send message utility, among other utilities. Parents and children are given rights to access and/or execute the different utilities of software program 102 based on their classification as a parent user or a child user.

FIG. 15 shows in block diagram form that in the embodiment of software 102 of FIG. 14, earned points value 128 is divided, or organized, into three different categories before being spent using an organize points utility of software program 102 according to the invention. Earned points 128 are collected or accumulated into a points to organize value 128. Earned points value 128 is organized (divided) into save points value 230, share points value 232, and spend points value 234. Reward list 182 is divided into save reward list 236, share reward list 238, and spend reward list 240. Save points 230 are used to purchase saving-related rewards from save reward list 236. In some embodiments save points are converted into money and put into one of several different type of savings accounts, such as a bank account or a college fund or an investment fund, or a rainy day fund for the child to contribute to until he or she wants to use the money for a special purchase. Save reward list 236 includes any type of saving-related reward that the parent user creates for the child user. Share points are used to purchase sharing-related rewards from share reward list 238. Share rewards are designed to allow the child user to share his or her time or money. For example but not by way of limitation, share points can be used to make a donation to a charity or church, or to spend time at a local shelter, or to otherwise allow the child to contribute charitably to society. Spend points are used to purchase spending-related rewards from spend reward list 240. Spend rewards can include products, trips, family time, computer time, or other rewards which the child enjoys. Spend rewards list 240 can contain rewards created by the parent user to provide enjoyment and motivation to the child user. The use of the organize points utility of software program 102 teaches children that earned wealth can be used for things other than spending immediately—that some portion of their earned goodwill should be saved, a portion should be given back to society to help others, and a portion can be used for their own enjoyment. In some embodiments parents can dictate that a certain percentage of earned points be organized into either save points 230, share points 232, or spend points 234. The organize points utility of software program 102 allows earned points 128 to be allocated to these different types of rewards. In some embodiments other point type categories are used instead of or in addition to spend points 230, share points 232, and save points 234.

FIG. 16 through FIG. 26 show embodiments of user interface screens created by software program 102 of FIG. 14. These user interface screens are displayed on monitor 166 of I/O device 116. Users 250 utilize these user interface screens, and others, to interface with software program 102. In some embodiments of machine for tracking job completion 101, these user interface screens are displayed on other devices besides monitor 166. In some embodiments user interface screens are displayed on a phone display, or a mobile device display, or a laptop display or a PDA display. The user interface screens can be used with any I/O device that displays images provided for user interaction. It should be understood that in some embodiments of machine for tracking job completion 101, users interact with software program 102 using interface means other than images.

FIG. 16 shows family member definition screen 258 created by the family member definition utility of software program 102. In this embodiment parent users utilize family member definition screen 258 to define and classify family members and use the family member definition utility. Family member users are identified by either or both of a user name 144, which is entered into name definition field 264, or a user photo 122, which is entered using add photo designator 262. Family member type radio button 260 is used to classify each family member as either a parent user (administrator) or a child user (participant). Family member definition utility selector 259 is clicked to have the family member definition utility save the new or modified family member data. In this way software program 102 presents family member definition screen 258 to parent users for use in adding and defining family member user data. In this way software program 102 presents family member definition screen 258 to parent users for use in accessing or executing the family member definition utility of software program 102.

FIG. 17 shows family log-in screen 266 created by software program 102 of FIG. 14. When one of users 250 indicates to software program 102 that they would like to log-in to software program 102, software program 102 displays family log-in screen 266 in response. Software program 102 recognizes I/O device 116 as belonging to a family set 252 or a family member, and displays a list of family members in family set 252 in response. List of family members 252 can include family member names 144, family member photos 122, or both. Only those users that belong to the user's family are displayed in family member list 252 on family member log-in screen 266. The family member that desires to log-in to software program 102 selects the name 144 or photo 122 that belongs to them. Software program 102 then provides password field 265 for the family member to enter their password and log-in button 267 for the family member to use to log-in to software program 102. In this way software program 102 allows family members to select from a list of family members 252, enter their password, and log-in to software program 102 of machine for tracking job completion 101.

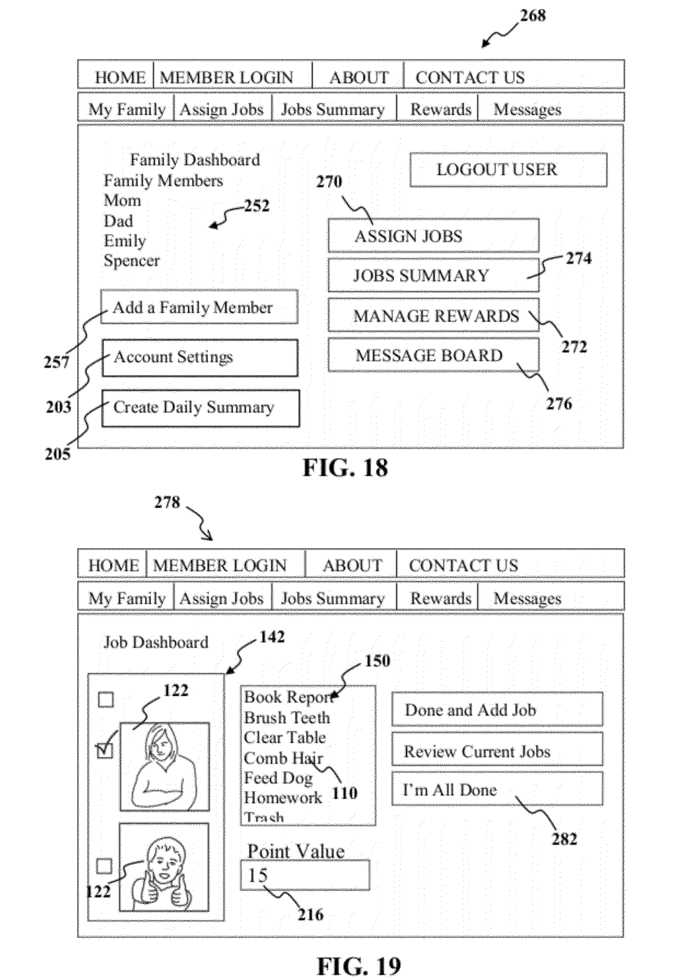

The user interface screens and options that are presented by software program 102 to the family member user after log-in by the family member user depends on the classification of the family member user as either a parent/administrator or a child/participant user. A family member user that logs in using family log-in screen 266 and is classified as a parent user is presented with family dashboard screen 268 as shown in FIG. 18. A family member user that is classified as a child user is presented with job tracking screen 312 as shown in FIG. 24. A parent is presented with different options and utilities to run, access or execute using software program 102 than a child is presented with. In this way software program 102 divides up users 250 into parents and children, and allows the parents and children to perform different operations using software program 102.

Family dashboard screen 268 is presented to family members that are classified as parent users upon successful completion of log-in. FIG. 18 shows one embodiment of family dashboard screen 268 according to the invention. Family dashboard screen 268 shows family set list 252, as well as several buttons which allow the parent access to a number of different screens, which in turn allow the parent to access and/or execute several software utilities included in software program 102. Family dashboard screen 268 includes family member definition screen selector 257 which, when selected, sends the parent user to the family member definition screen of FIG. 16. Family dashboard screen 268 is the “home screen” for parent users and allows the parent user access to utilities and interface screens which allows the parent user to create and assign jobs, create and assign rewards, and in general interface, modify and control the data belonging to the family set 252 that the parent user is a part of. Family dashboard screen 268 includes assign jobs screen selector 270, job summary screen selector 272, manage rewards screen selector 274, and message board screen selector 276.

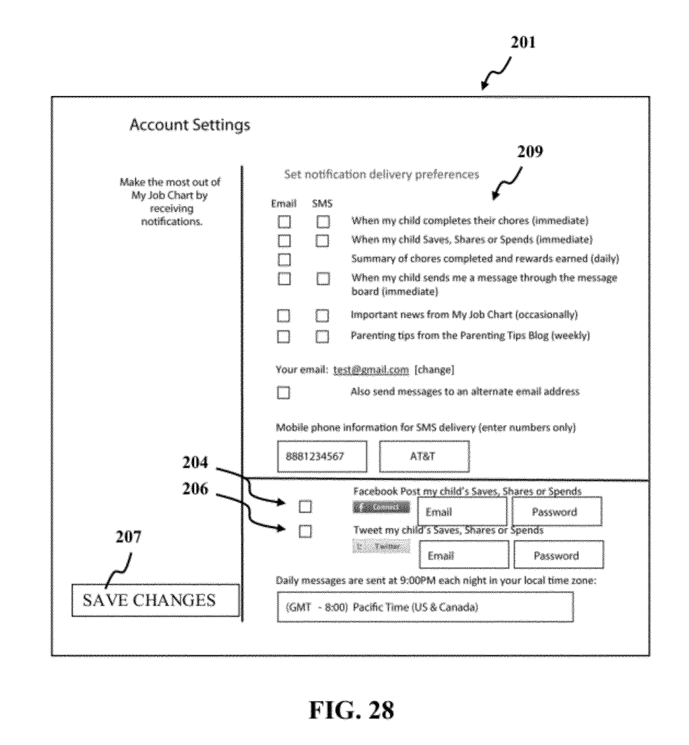

Family dashboard screen 268 in this embodiment includes accounts setting selector 203 and create daily summary selector 205. Accounts setting selector 203 allows the parent user to select how and when the progress of a child is reported. Choosing account setting selector 203 displays account setting screen 201 as shown in FIG. 28, to be discussed shortly in the description of that figure. Choosing create daily summary selector 205 creates a report that details the progress of one or more child users. The daily summary can be used by the parent to track a child user's progress. The daily summary can be posted by the parent user or the child user to a social networking site, for example, to publicize the progress of a child. The daily summary can be used as a progress report to track, organize, publicize, and itemize the progress a child has made in reaching their goals.

Family dashboard screen 268 includes assign job screen selector 270 which when selected (clicked, chosen, activated), provides the family member classified as a parent user with assign jobs screen 278 as shown in FIG. 19. Assign jobs screen 278 is used by the parent user to create job list 150 including job names 110 and job data 154 belonging to participant profiles 120. Assign jobs screen 278 allows the parent user to create and modify the data included in participant profile 120. Assign job screen 278 shows participant list 142, which is a list of all of the users from family set list 252 that are classified as a child. Participant list 142 is a list of either the user names 144, the user photos 122, or both, of the children in the family. Parent users choose which child participant they would like to assign a job to. Assign jobs screen 278 allows the parent to create job data 154 by assigning a job name 110 and job point value 216 to the job list 150 belonging to each child on participant list 142. Assign jobs screen 278 includes assign job utility selector 282 which when selected runs the assign jobs utility of software program 102. The assign job utility places the job name 110 and job data 154 on the child's job list 150 of participant profile 120 belonging to the child identified by participant name 144 or participant photo 122. In this way assign jobs screen 278 allows the parent user to create and modify participant profile 120 data. In this way assign jobs screen 278 allows the parent user to use, access or execute the assign jobs utility. Assign jobs screen 278 is accessed using family dashboard screen 268. In this way family dashboard screen 268 allows a parent to access and/or execute the assign jobs utility of software program 102. In this way software program 102 allows a family member classified as a parent to use, access, or execute the assign job utility of software program 102.

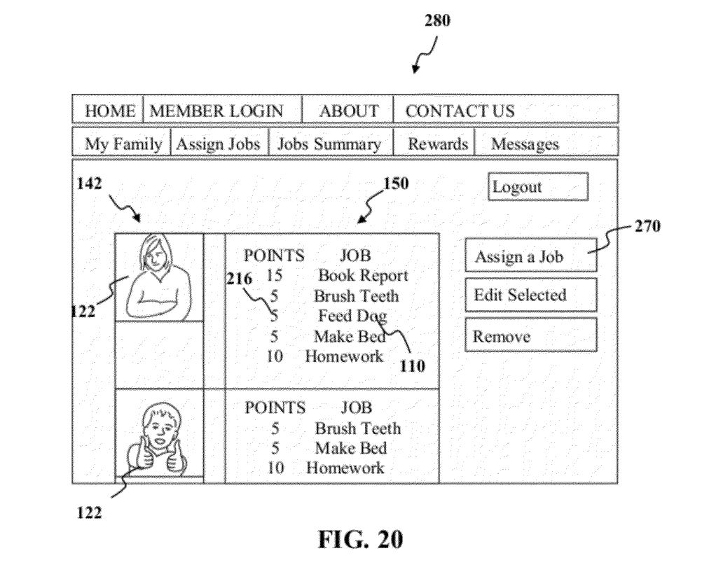

Family dashboard screen 268 includes jobs summary screen selector 272 which when selected, presents the family member classified as a parent user with jobs summary screen 280 as shown in FIG. 20. Jobs summary screen 280 is another screen which allows the parent to view the job list 150 and modify the job data 154 assigned to the children that are members of the particular family set 252 that the parent user belongs to. Jobs summary screen 280 includes participant list 142, which lists the names 144 or photos 122 of the child members of the family the parent belongs to. Jobs summary screen 280 allows access to assign jobs screen 278 through assign jobs screen selector 270. In this way jobs summary screen 280 allows a parent to access, modify, and update the job list 150 and job data 154 of software program 102. In this way software program 102 allows a family member classified as a parent to access and modify job list 150 and job data 154 of software program 102.

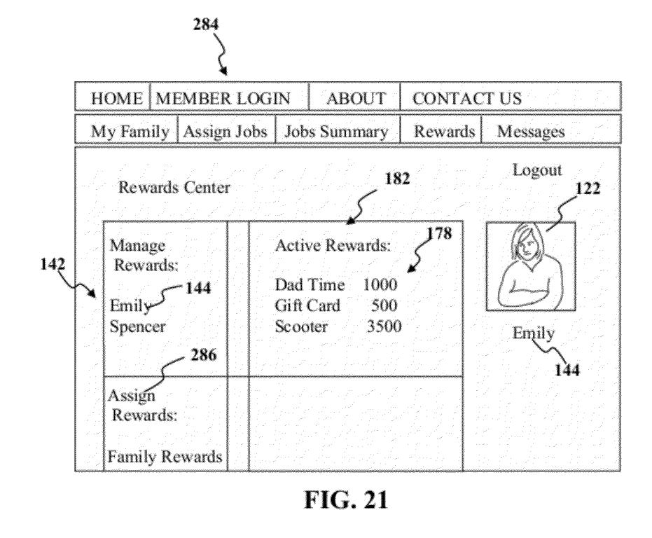

Family dashboard screen 268 includes manage rewards screen selector 274 which when selected, provides the family member classified as a parent with manage rewards screen 284 as shown in FIG. 21. Manage rewards screen 284 shows child list 142 which lists the participant name 144 corresponding to each child user on child list 142. When a participant name 144 is chosen, manage rewards screen 284 shows the rewards list 182 associated with participant name 144 from child list 142. Manage reward screen 284 allows the parent user to interact with reward list 182, which is the list of rewards available for each child user belonging to participant list 142. Manage rewards screen 284 allows the parent to view reward list 182, and reward point values 178. In this way manage rewards screen 284 allows a parent to access or change reward list 182 of software program 102. In this way software program 102 allows a family member classified as a parent to access reward list 182 of software program 102.

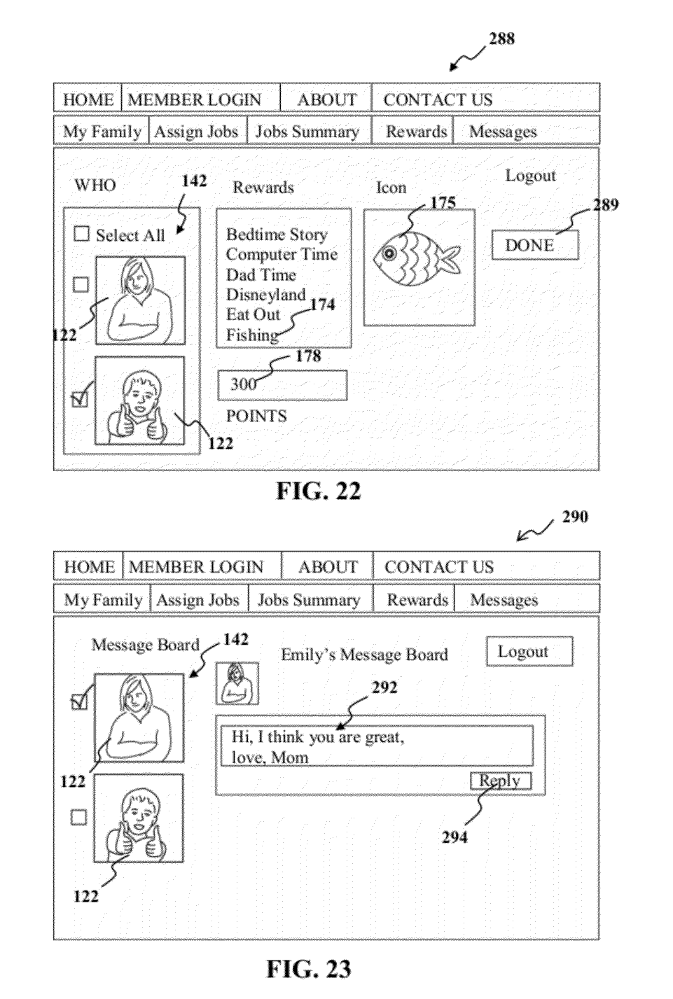

Manage rewards screen 284 includes several assign rewards screen selectors. Choosing the family rewards assign rewards screen selector 286 presents assign rewards screen 288 as shown in FIG. 22. Assign rewards screen 288 shows child list 142 and in this embodiment shows the user picture 122 corresponding to each child user on child list 142. Assign reward screen 288 allows the parent user to define reward name 174, reward icon 175, and reward point value 178 of reward data 176. Assign rewards screen 288 includes assign rewards utility selector 289. Assign rewards utility selector 289, when selected, executes the assign rewards utility of software program 102. The assign rewards utility places the reward data 176 defined using assign rewards screen 288 onto reward list 182 of the child selected from participant list 142 using child name 144 or child photo 122. The assign rewards utility allows the parent user to create save reward names 195 and saver reward lists 236, create share reward names 196 and share reward lists 238, and spend reward names 197, and to assign the reward names and lists to a child user. The assign rewards utility allows the parent user to create a spend reward list 240 that includes spend reward names 197 and spend reward point values 194 associated with the spend reward names. In this way assign reward screen 288 allows a parent user to access and modify reward list 182, reward names 174, and reward data 176. In this way assign reward screen 288 allows a parent to access and execute an assign rewards utility of software program 102. In this way software program 102 allows a family member classified as a parent to execute or use an assign rewards utility of software program 102.

Family dashboard screen 268 includes message board screen selector 276 which when selected presents parent message board screen 290 as shown in FIG. 23. Parent message board screen 290 shows child list 142 and in this embodiment shows the child user picture 122 corresponding to each child user on child list 142. The parent user is able to select the child picture 122 which corresponds to the child user they would like to send a message to, and then enter message 292 in the space designated for entering messages. Message 292 is sent to the child using the parent send message utility when the parent selects the parent send message utility selector 294. Message 292 will then be displayed on the child's job tracking screen 312 as shown in FIG. 24. The parent send message utility stores message 292 and displays message 292 on the child's job tracking screen 312 in response to parent send message utility selector 294 being placed in a ‘send message’ state. Parent message board screen 290 includes parent send message utility selector 294 which when selected runs a parent send message utility of software program 102. In this way parent message board screen allows a parent user to access or execute a parent send message utility of software program 102. In this way software program 102 allows a family member classified as a parent to use a parent send message utility of software program 102. In some embodiments the parent send message utility allows the parent user to set limits on the ability of a child user to send and/or receive messages into and out of software program 102. The parent user may want to limit the ability of a child user to communicate with the outside world with software program 102, for safety, security, privacy, or any other reasons. For example, but not by way of limitation, the parent user may select settings for the child users message utility that allows them only to communicate with parent users, without messages ever exiting software program 102. This may be appropriate for child users below a particular age, for example. In some embodiment the parent user may allow the child user to communicate outside software program 102 using email, texting, tweets, social networking sites or other electronic socializing and communications abilities.

In some embodiments of software 102 of machine for tracking job completion 101, parent message board screen 290 also allows the parent to view and respond to messages received from other family members. In this way software program 102 allows secure message transfer between parents and children and between children and parents.

Family dashboard screen 268 allows family members classified as parent users to access and/or execute an assign jobs utility, a manage rewards utility, a family member definition utility, and a parent send message utility. The assign jobs utility is accessed by parents by using assign jobs screen selector 270 and job summary screen selector 272 as shown on family dashboard screen 268 to access assign jobs screen 278 and job summary screen 280. Assign jobs screen 278 and jobs summary screen 280 allow the parent user to manipulate participant profile data 120, manipulate job data 154, and execute the assign jobs utility using assign jobs utility selector 282. The assign jobs utility allows each parent user to assign a job name to a child user. The assign rewards utility is accessed by parents by using manage rewards screen selector 274 as shown on family dashboard screen 268 to access manage rewards screen 284 and assign reward screen 288. Manage rewards screen 284 and assign reward screen 288 allow the parent user to manipulate reward data and reward list 182 and execute the assign rewards utility using assign rewards utility selector 289. The parent send message utility is accessed by parents by using message board screen selector 276 as shown on family dashboard screen 268 to access parent message board screen 290. Parent message board screen 290 allows a parent user to write and assign messages, and execute parent send message utility using parent send message utility selector 294. In this way family members classified as parent users are allowed access to an assign jobs utility, an assign rewards utility and a parent send message utility. In this way family members are allowed access to an assign jobs utility, an assign rewards utility and a parent send message utility in response to being classified as a parent user.

A family member that logs in using family log-in screen 266 and is classified as a child user is presented with job tracking screen 312 as shown in FIG. 24. FIG. 24 shows one embodiment of job tracking screen 312 according to the invention as created by software program 102 of machine for tracking job completion 101. Job tracking screen 312 is used by the child user to access job completion utility 160 and get credit for jobs completed. Job tracking screen 312 shows child name 144, child photo 122, and job list 150 that is assigned to the child. Job tracking screen 312 shows job data 154 associated with each job, which includes job name 110, job point value 216, and job completion indicator 158. The child puts job completion indicator 158 for each job they have completed into the “job completed” mode by entering a check mark in the job completion indicator box associated with the job, and then executes job credit utility 160 by selecting job credit utility selector 314. Job credit utility 160 will then give the child credit for each completed job as explained earlier in regard to FIG. 3 through FIG. 6. Job tracking screen 312 includes job credit utility selector 314 which allows the child to execute job credit utility 160. In this way job tracking screen 312 allows a child user to access or execute job tracking utility 160 of software program 102. In this way software program 102 allows a family member classified as a child user to use job tracking utility 160 of software program 102.

Job tracking screen 312 also allows the child to view and reply to message 292 from their parent. Message 292 is shown on job tracking screen 312 after it is sent by a parent user using the parent send message utility of software program 102. The child can read message 292 and use child message reply selector 296 to write and send a reply message to the parent if the child desires. Child message reply selector 296 allows the child user to use, access, and execute the child send message utility of software program 102. In this way job tracking screen 312 allows the child to receive and send secure messages to and from other family members. In this way software program 102 allows a user classified as a child user to use, access, and execute a child send message utility of software program 102.

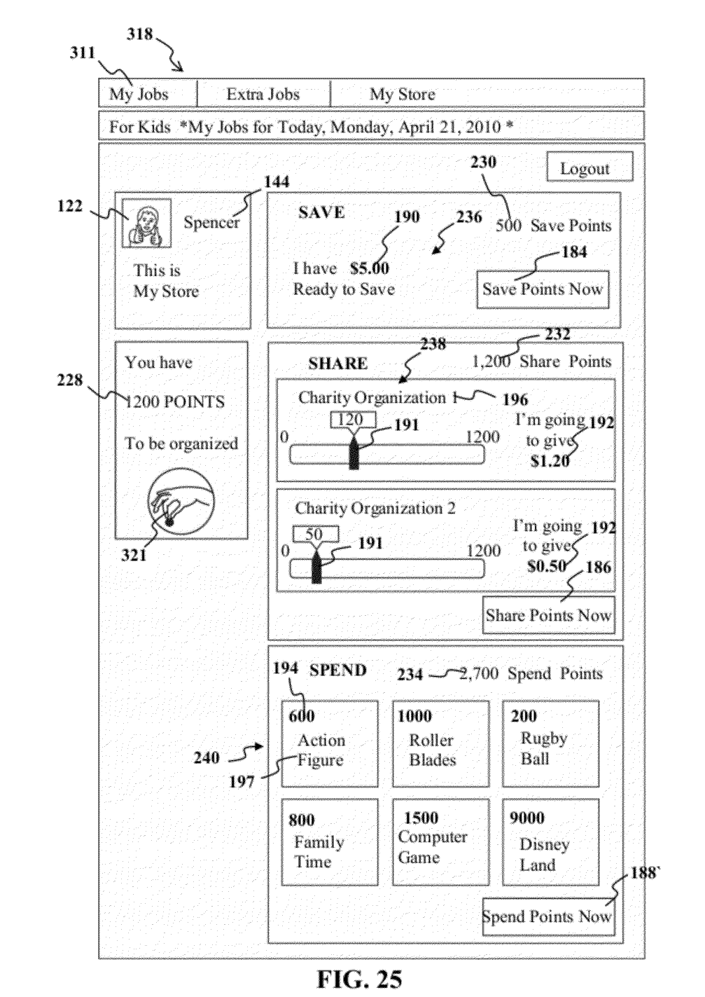

Job tracking screen 312 also includes reward store screen selector 316, which when selected displays reward store screen 318 as shown in FIG. 25. FIG. 25 is one embodiment of reward store screen 318 according to the invention. Reward store screen 318 shows child name 144, child photo 122 belonging to the child user, and the rewards from reward list 182 that the child can purchase, which in this embodiments are divided up into save reward list 236, share reward list 238, and spend reward list 240. Reward store screen 318 allows the child user to place rewards on reward shopping cart list 172 (FIG. 3 through FIG. 9) and subsequently purchase those rewards using reward purchase utility 160. Rewards on save reward list 236 can include financial institutions such as banks, savings and loan companies, credit unions, investment companies, or any other institution that will allow saving and/or investment of the child user's save points 230. Each savings institution can be assigned a save reward name. Rewards on save reward list 236 can each include a save reward name and a save reward point value 190 which is the number of points the save reward costs to purchase. A non-zero value for save reward point value 190 places the save reward name on reward shopping cart list 172. Save rewards are purchased by the child selecting save reward purchase utility selector 184 which puts purchase indicator 180 for the save rewards on reward shopping cart list 172 into the “purchased” mode and executes reward purchase utility 320 as explained with regard to FIG. 6 through FIG. 9. In this case when rewards are ‘purchased’, a portion of the child's earned points are converted into a monetary value and allocated to the specific savings fund, which can be, for example but not by way of limitation, a bank account, an investment account, an education fund, or an amount of money the parents are holding for the child. In this embodiment when save rewards are purchased, first the child user selects a value for save reward point value 190. Save reward point value 190 indicates how many points from save points value 230 the child would like to “spend”—place into savings. The child user then clicks save reward purchase utility selector 184, which executes the “purchase” of the save reward, which subtracts save reward point value 190 from save points value 230 and adds save reward point value 190 to a designated save account, or instructs the parent user. A save reward can represent any reward that represents a portion of the child's earned points are set aside for use in the future. In some embodiments other types of save rewards are used. In some embodiments software program 102 and reward store screen 318 allows the child user to have email or internet access to a bank or savings institution to facilitate deposits of money or other interactions. In some embodiments the parent user is the one to interact directly using email or web pages with companies or institutions associated with save rewards. In some embodiments the reward purchase utility instructs the microprocessor to assign save reward point value 190 to a save reward name, subtract save reward point value 190 from save points value 230, and add the save reward name to rewards purchased list 170. In some embodiments the reward purchase utility further instructs the microprocessor to post the save reward name to a social networking site.

Rewards on the share reward list 238 each include a share reward name 196 and a share reward point value 192 which is the number of points the share reward costs to purchase. Some of the share reward names 196 can be the name of a charity organization that the child user might like to contribute to. In this embodiment each share reward name on share reward list 238 has a share reward slider 191 which allows the child to select the value of points for share reward point value 192. In this way the child user uses the reward purchase utility to assign a share reward point value 192 to share reward name 196. A non-zero value of share reward point value 192 places that share reward name 196 on the reward shopping cart list 172. Share rewards are purchased by the child selecting share reward purchase utility selector 186 which puts purchase indicator 180 for the share rewards on reward shopping cart list 172 into the “purchased” mode and executes reward purchase utility 320 as explained with regard to FIG. 6 through FIG. 9. When share reward name 196 is purchased by the child user using the reward purchase utility, the reward purchase utility instructs the microprocessor to subtract share reward point value 192 from share points value 232, and add share reward name 196 to rewards purchased list 170. In this case when a share reward is “purchased”, a portion of the child's earned points are used to send some money to a charity, for example, or otherwise contribute to a charitable cause. In some embodiments software program 102 and reward store screen 318 allows the child user to have internet or email access to a charity or church or other organization to facilitate donations of money or other interactions. In some embodiments the parent user is the one to interact with the groups or companies associated with share rewards. In some embodiments the parent user utilizes email or web pages to interact with the groups of companies associated with share rewards. In some embodiments share reward point values represent a certain portion of a child's time that they are going to spend working for a cause, for example. Share rewards and their associated point values are used to allow the child to learn how to enrich the lives of others by using the child's earned points. In some embodiments the reward purchase utility instructs the microprocessor to assign share reward point value 192 to a share reward name, subtract share reward point value 192 from share points value 232, and add the share reward name to rewards purchased list 170. In some embodiments the reward purchase utility further instructs the microprocessor to post the share reward name to a social networking site. Rewards on the spend reward list 240 each include a spend reward name 197 and spend reward point value 194 which is the number of points the spend reward costs to purchase. In this embodiment spend reward name 197 is are placed on reward shopping cart list 172 by clicking on the spend reward name 197 icon. Spend rewards are purchased by the child selecting spend reward purchase utility selector 188 which puts purchase indicator 180 for the spend rewards on reward shopping cart list 172 into the “purchased” mode and executes reward purchase utility 320 as explained with regard to FIG. 6 through FIG. 9. In some embodiments software program 102 and reward store screen 318 allows the child user to have email or internet access to store or company web pages to facilitate product purchase or other interactions. In some embodiments the parent user is the one to interact with web pages of groups or companies associated with spend rewards. In a particular embodiment software program 102 includes links to Amazon.com web pages. In some embodiments software program 102 has links to other web pages.

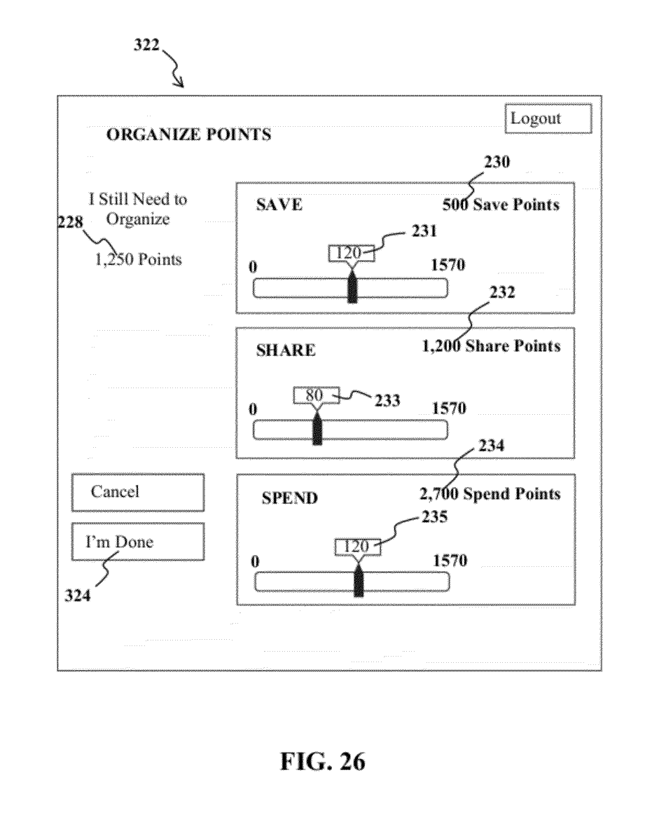

Reward store screen 318 shows save points value 230, which represents the amount of points the child has to spend on save rewards, and share points value 232, which represents the amount of points the child has available to spend on share rewards, and spend points value 234, which represents the amount of points the child has available to spend on spend rewards. The total amount of points that the child has earned are divided into save point value 230, share point value 232, and spend point value 234 using an organize points utility of software program 102. Earned point value 128 is temporarily stored as points to organize 228 (see FIG. 15 and FIG. 25) by an accumulate points utility of software program 102, and displayed as shown on reward store screen 318 until these points are divided up into save point value 230, share point value 232, and spend point value 234. The accumulate points utility adds earned point value 128 to points to organize value 228, accumulating earned points 128 in points to organize value 228 until the child user is ready to organize the points—or divide them up into save point value 230, share point value 232, and spend point value 234. When the child is ready to divide the points to organize 228 into save point value 230, share point value 232, and spend point value 234, they select organize points screen selector 321 which displays organize points screen 322 as shown in FIG. 26. Organize points screen 322 allows the child user to execute the organize points utility of software program 102. Organize points screen 322 shows the total number of points to organize 228, and slider bars which allows the child to select the organize save points value 231, which represents the number of points to organize 228 to be allocated to save points 230, and the organize share points value 233, which represents the number of points to organize 228 to be allocated to share points 232, and the organize spend points value 235, which represents the number of points to organize 228 to be allocated to spend points 234. The organize save point value, the organize share point value, and the organize spend point value are saved by the organize points utility. When the organize points utility selector 324 is selected, the organize points utility of software program 102 performs the following operations: 1) it subtracts the organize save points value 231 from the points to organize value 228 and adds the organize save points value 231 to the save points value 230, 2) it subtracts the organize share points value 233 from the points to organize value 228 and adds the organize share points value 233 to the share points value 232, and 3) it subtracts the organize spend points value 235 from the points to organize value 228 and adds the organize spend points value 235 to the spend points value 234. The child is sent back to reward store screen 318, where save point value 230, share point value 232, spend point value 234, and points to organize value 228 will have their new values based on the operation of the organize points utility. In this way a family member classified as a child is allowed to access and execute an organize points utility of software 102. The organize points utility divides up a points to organize 228 value into save points 230, share points 232, and spend points 234 in response to execution of the organize points utility. As shown in FIG. 15, the child can then use save points 230 to purchase save rewards from save reward list 236, share points 232 to purchase share rewards from share reward list 238, and spend points 234 to purchase spend rewards from spend reward list 240. In this way a child user of software program 102 of machine for tracking job completion 101 is allow to access and execute the organize points utility. In this way a user of software program 102 is allowed to access and execute the organize points utility in response to being classified as a child user.

Reward store screen 318 also has job tracking screen selector 311 which sends the child back to job tracking screen 312. Job tracking screen 312 of software program 102 allows the child access to job credit utility 160, the organize points utility, the child send message utility, and reward purchase utility 320. In this way family members are allowed access to job credit utility 160, reward purchase utility 320, the organize points utility and the child send message utility in response to being classified as a child user.

It is to be understood that the user interface screens shown in this document are examples only. Many other embodiments of user interface screens may be used according to the invention by software program 102 to allow machine for tracking job completion 101 to track jobs and job completion.

FIG. 27 shows computerized method 330 of spending earned points in a machine for tracking job completion according to the invention. Method 330 includes step 331, accumulating, or collecting, earned points into a points to organize value. The point values earned by the child participant for completing jobs are stored in the points to organize value until the child is ready to divide the points up among points to be saved, points to be shared, and points to be spent. Method 330 includes step 332 dividing the points to organize value into a save points value, a share points value, and a spend points value. In some embodiments the organize points utility of software program 102 is used to divide up the points to organize into different categories. In some embodiments of method 332 a slider bar user interface is used to identify an organize save points value, which is the amount of the points to organize value to be allocated by the organize points utility to the save points value. In some embodiments of method 332 a slider bar user interface is used to identify an organize share points value, which is the amount of the points to organize value to be allocated by the organize points utility to the share points value. In some embodiments of method 332 a slider bar user interface is used to identify an organize spend points value, which is the amount of the points to organize value to be allocated by the organize points utility to the spend points value. In some embodiments method 332 includes other steps.

Method 330 of spending earned points in a machine for tracking job completion includes step 333 spending save points by purchasing save rewards. The child is allowed to use save points to purchase save rewards from a save reward list, which includes rewards defined by the parent user that are related to saving earned points. In some embodiments the save reward list includes one or more than one name of a financial institution. Method 330 of spending earned points in a machine for tracking job completion includes step 334 spending share points by purchasing share rewards. The child is allowed to use share points to purchase share rewards from a share reward list, which includes rewards defined by the parent user that are related to sharing earned points. In some embodiments the share reward list includes one or more than one name of a charity organization. Method 330 of spending earned points in a machine for tracking job completion includes step 335 spending spend points by purchasing spend rewards. The child is allowed to use spend points to purchase spend rewards from a spend reward list, which includes rewards defined by the parent user that are related to spending earned points.

In some embodiments method 330 includes other steps. In some embodiments organized points are allocated into different bins and used to purchase different types of rewards. In some embodiments method 330 includes the step of choosing a save reward name from a save reward list. In some embodiments method 330 includes the step of choosing a share reward name from a share reward list. In some embodiments method 330 includes the step of choosing a spend reward name from a spend reward list. In some embodiments method 330 includes the step of assigning a save reward point value to the save reward name. In some embodiments method 330 includes the step of assigning a share reward point value to the share reward name. In some embodiments method 330 includes the step of assigning a spend reward point value to the spend reward name.

FIG. 28 shows account setting screen 201. Accounts setting screen 201 is used by a parent user to access and/or execute an account setting utility. The account setting utility and account setting screen 201 are used to select how and when a child user's progress towards reaching goals is reported. The list of reporting settings are shown as account setting list 209 as shown in one embodiment in FIG. 28. The parent user can have progress report automatically sent to the parent user when a child completes daily chores, for instance, or when they redeem reward points. The parent user can have a daily summary detailing the progress of a child user sent to the parent user via email, texting, or other electronic communication. The parent user can elect to receive communication whenever a child user saves, spends, or shares reward points. The parent user can elect to have some or all of a child user's progress posted to social networking sites such as Facebook or Twitter, for example but not by way of limitation. The parent user can elect to have the progress of a child reported to the parent user at specific times of the day. The parent user can elect to have the progress of a child reported to other individuals—a teacher, a family member, a friend, for example. The various account setting options are listed on account setting screen 201 in account setting list 209, one example of which is shown in FIG. 28. After the parent user selects the specific account settings they desire for the progress reporting features they which to choose, the parent user executes the account setting utility to enact the particular account settings. The account setting utility is executed by selecting account setting utility selector 207.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, software program 102 can be used by businesses and sports teams to track job completion.

1. A machine for tracking job completion comprising:
a microprocessor coupled to a memory; and
a software program installable on the memory and operated by using the microprocessor,
the software program comprising:
an accumulate points utility, wherein the accumulate points utility instructs the microprocessor to add an earned point value to a points to organize value;
and
an organize points utility, wherein the organize points utility instructs the microprocessor to perform the following steps:
subtract an organize save points value from the points to organize value; and
add the organize save points value to a save points value.

2. The machine of claim 1, wherein the organize points utility instructs the microprocessor to further perform the following steps:
subtract an organize share points value from the points to organize value;
and
add the organize share points value to a share points value.

3. The machine of claim 2, wherein the organize points utility instructs the microprocessor
to further perform the following steps:
subtract an organize spend points value from the points to organize value;
and
add the organize spend points value to a spend points value.

4. The machine of claim 3, wherein the software program further comprises an assign rewards utility, wherein the assign rewards utility instructs the microprocessor to perform the following steps:
create a save reward name;
assign the save reward name to a user of the software program that is classified as a child;
store a share reward name;
assign the share reward name to the child user;
create a spend reward list comprising a spend reward name and a spend reward point value, wherein the spend reward point value is associated with the spend reward name;
and
assign the spend reward list to the child user.

5. The machine of claim 4, where the software program further comprises a reward purchase utility, wherein the reward purchase utility instructs the microprocessor to perform the following steps:
assign a share reward point value to the share reward name;
subtract the share reward point value from the share points value;
and
add the share reward name to a rewards purchased list.

6. The machine of claim 5, wherein the reward purchase utility further instructs the microprocessor to perform the following step:
post the share reward name to a social networking site.

7. The machine of claim 5, wherein the software program restricts access to the assign rewards utility such that a user of the software program is allowed to access the assign rewards utility only if the user is registered as a parent user.

8. A memory with an executable software program stored thereon, wherein the software program instructs a microprocessor to perform the following steps:
register a plurality of users of the software program;
and
divide up the plurality of users of the software program into a plurality of family sets, wherein each family set includes at least two users of the software program.

9. The memory with an executable software program stored thereon of claim 8, wherein the software program further instructs the microprocessor to perform the following steps:
classify at least one user in each family set as a parent user;
and
classify at least one user in each family set as a child user;
wherein users of the software program can be classified as either a parent user or a child user, but not as both a parent user and a child user.

10. The memory with an executable software program stored thereon of claim 9, wherein the software program further instructs the microprocessor to perform the following steps:
allow each parent user to execute an assign jobs utility, wherein the assign jobs utility assigns a job name to a child user;
and
restrict each child user from executing the assign jobs utility.

11. The memory with an executable software program stored thereon of claim 9, wherein the software program further instructs the microprocessor to perform the following steps:
allow each parent user to execute an assign rewards utility, wherein the assign rewards utility stores a share reward list comprising a share reward name;
and
restrict each child user from accessing the assign rewards utility.

12. The memory with an executable software program stored thereon of claim 11, wherein the software program further instructs the microprocessor to perform the following step:
allow a child user to execute an organize points utility, wherein the organize points utility stores an organize save points value, an organize share points value, and an organize spend points value.

13. The memory with an executable software program stored thereon of claim 12, wherein the organize points utility instructs the microprocessor to perform the following steps:
subtract the organize share points value from a points to organize value;
and
add the organize share points value to a share points value.

14. The memory with an executable software program stored thereon of claim 13, wherein the software program further instructs the microprocessor to allow the child user to execute a reward purchase utility, wherein the reward purchase utility instructs the microprocessor to perform the following steps:
store a share reward point value, wherein the share reward point value is associated with the share reward name;
and
subtract the share reward point value from the share points value.

15. A computer performed method of spending earned reward points, the method comprising the steps of:
accumulating earned points into a points to organize value;
dividing the points to organize value into a save points value, a share points value, and a spend points value;
spending save points by purchasing a save reward;
spending share points by purchasing a share reward;
and
spending spend points by purchasing a spend reward.

16. The method of claim 15, further comprising the steps of:
choosing a save reward name from a save reward list;
choosing a share reward name from a share reward list;
and
choosing a spend reward name from a spend reward list.

17. The method of claim 16, wherein the save reward list is created by a parent user.

18. The method of claim 16, further comprising the steps of:
assigning a save reward point value to the save reward name;
and
assigning a share reward point value to the share reward name.

19. The method of claim 18, further comprising the step of converting share points to a monetary value.

20. The method of claim 19, wherein the share reward list comprises one or more than one name of a charity organization.
